(19) United States
(12) Patent Application Publication
(10) Pub. No.: US 2026/0176508 A1
(43) Pub. Date: Jun. 25, 2026

(54) ARCHITECTURED POLYMERS AND RELATED METHODS

(71) Applicant: Avery Dennison Corporation, Mentor, OH (US)

(72) Inventors: William L. BOTTORF, Mill Hall, PA (US); Yunli FANG, Concord, OH (US); Andrew FULL, State College, PA (US); Xiaochuan HU, State College, PA (US); Timothy SCHUNK, Painesville, OH (US); Colby D. SHELMIRE, South Williamsport, PA (US); Michael T. WATERMAN, Chardon, OH (US)

(21) Appl. No.: 19/127,136

(22) PCT Filed: Nov. 17, 2023
(86) PCT No.: PCT/US2023/080282

§ 371 Date: May 5, 2025

Related U.S. Application Data
(60) Provisional application No. 63/384,347, filed on Nov. 18, 2022.

(51) Int. Cl. C09J 133/26; C08F 2/48; C08F 220/06; C08J 3/24; C09J 7/38; C09J 133/10

(52) U.S. Cl. CPC C09J 133/26; C08F 2/48; C08F 220/06; C08J 3/24; C09J 7/385; C09J 133/10; C09J 2433/00

(57) ABSTRACT

Pressure sensitive adhesives that include architectured polymers are described. Also described are various methods for producing the noted polymers and pressure sensitive adhesives. In addition, a variety of articles including tapes utilizing the pressure sensitive adhesives are described.

### CROSS-REFERENCE TO RELATED APPLICATION(S)

This application claims the benefit of U.S. Provisional Application No. 63/384,347 filed Nov. 18, 2022, which is incorporated herein by reference in its entirety.

### TECHNICAL FIELD

The present subject matter relates to methods of preparing polymers and pressure sensitive adhesives with novel architecture signified with long chain branching. The present subject matter also relates to the pressure sensitive adhesives formed from the methods. Additionally, the present subject matter relates to tapes and other articles using the pressure sensitive adhesives.

### BACKGROUND

Solvent-based, acrylic, pressure-sensitive adhesives (PSAs) are used for high-performance applications because of their excellent balance of peel adhesion and cohesive strength. In general, the constituent polymers of such adhesives have high molecular weights, and the adhesives are characterized by high relative viscosity. Consequently, dilution with solvent is required to make the polymers coatable at ambient temperatures. They are typically coated at a solids content of from 30 to 40% by weight. The solvent is removed (evaporated) immediately following the coating process.

The lower the solids content of the solvent-based adhesive, the more time is required to drive off the solvent after coating. Consequently, it is necessary to employ very slow line speeds during the coating process to ensure a solvent-free coating that has no defects, such as bubbles or skinning. As a result, the cost of manufacturing solvent based acrylic products is high.

Acrylic hot-melt or warm melt adhesives were developed to try to match the adhesive performance of solvent-based adhesives while lowering the cost of coating by increasing line speeds. The molecular weight of such adhesives has to be lower than traditional solvent-based acrylics to ensure that the viscosity of the adhesive (100% solids content) is kept within a processable range. This lower molecular weight results in a lower cohesive strength, as shown by low shear performance. Therefore, the adhesive needs to be crosslinked after coating. Unfortunately, excessive crosslinking results in low adhesive peel and tack performance.

A continuing need exists not only for polymers that span a wide range of molecular weights and that can be tuned for use in different applications such as, but not limited to, high molecular weight, high performance PSAs that have an excellent balance of peel adhesion and cohesive strength, but also for compositions that can be coated and crosslinked at high speeds to form such PSAs, particularly compositions that can be coated both as a hot melt or warm melt and as a high solids content coatings.

### SUMMARY

The difficulties and drawbacks associated with previous approaches are addressed in the present subject matter as follows.

Architectured polymer compositions, and methods of making and using thereof are described herein. In some embodiments, the present subject matter provides a polymer composition comprising, consisting essentially of, or consisting of a crosslinkable reaction product prepared by the reaction of, or copolymerization of, or derived from a mixture comprising, consisting essentially of, or consisting of (1) one or more monomer comprising or consisting of a single polymerizable ethylenically unsaturated bond, wherein the one or more monomer is selected from the group consisting of (meth)acrylate, (meth)acrylamide, non-(meth)acrylate, and combinations thereof, (2) one or more initiator; and (3) a functional agent comprising one or more functional groups, wherein the crosslinkable reaction product comprises a polymer composition selected from the group consisting of a first polymer, a second polymer, and combinations thereof, and wherein any one or more of the following statements (A) to (D) applies to the polymer when present in tetrahydrofuran (THF) solution at 30° C. as determined by Gel Permeation Chromatography-Multi-Angle Light Scattering Detection-Differential Viscometry (GPC-MALS-DV):
(A) the polymer exhibits a weight average absolute molecular weight (Mw) of within a range of from about 10,000 to about 10,000,000 g/mol;
(B) the polymer exhibits a polydispersity index (PDI) of less than or equal to about 4.0;
(C) the polymer exhibits an α value of less than about 0.70 calculated according to the Mark-Houwink-Sakurada equation

[η]=KM^{a}
wherein,
[η] is an intrinsic viscosity of the polymer of absolute molecular weight M; and
(D) the polymer exhibits a weight average branching ratio g′w value equal to or less than about 0.90 calculated according to the equation

g′w=[ηb]/[ηl]
wherein,
[ηb] is the intrinsic viscosity of the polymer and [ηl] is the intrinsic viscosity of a reference linear polymer measured under the same solvent and temperature conditions, both having the same molecular weight (M), the molecular weight determined by GPC-MALS-DV.

In some embodiments, the polymer is as described above and in tetrahydrofuran (THF) solution at 30° C. exhibits a weight average absolute molecular weight (Mw) of greater than about 300,000 g/mol as determined by GPC-MALS-DV.

In some embodiments, the polymer is as described above and in tetrahydrofuran (THF) solution at 30° C. exhibits a weight average absolute molecular weight (Mw) of within a range of from about 400,000 to about 10,000,000 g/mol as determined by GPC-MALS-DV.

In some embodiments, the polymer is as described above and in tetrahydrofuran (THF) solution at 30° C. exhibits a polydispersity index (PDI) of from about 1.5 to less than or equal to about 4.0 as determined by GPC-MALS-DV.

In some embodiments, the polymer is as described above and comprises a polymer selected from the group comprising, but not limited to, star, dendritic, comb, brush, graft, pom-pom, hyperbranched polymers, and combinations thereof.

In some embodiments, the polymer described above upon at least partially crosslinking forms an adhesive.

In some embodiments, the polymer described above upon at least partially crosslinking forms an adhesive exhibiting a plateau shear modulus at 25° C. and 1 radian per second that is between 10⁴ and 10⁷ dynes/cm² as determined by dynamic mechanical analysis (DMA).

In some embodiments, the post-polymerized polymer described above upon at least partially crosslinking forms a pressure sensitive adhesive.

Methods for producing controlled architecture polymers that span a wide range of molecular weights as described above are also described herein.

The compositions and methods described herein overcome the limitations of current commercial products by creating controlled architecture polymers that span a wide range of molecular weights and can be tuned for use in different applications such as, but not limited to, high molecular weight, high performance PSAs that have an excellent balance of peel adhesion and cohesive strength, but also compositions that can be coated and crosslinked at high speeds to form such PSAs, particularly compositions that can be coated both as a hot melt or warm melt and as a high solids content coatings.

### DETAILED DESCRIPTION

### I. Definitions

The accompanying drawings are representative of some, but not all embodiments described herein. The claims should not be construed as limited to the embodiments set forth herein; rather, these embodiments are provided so that this disclosure will satisfy applicable legal requirements. Like numbers refer to like elements throughout.

As used in the specification, and in the appended claims, the singular forms “a”, “an”, “the”, include plural referents unless the context clearly dictates otherwise.

As used herein, “a,” “an,” “the,” “at least one,” and “one or more” are used interchangeably. Thus, for example, a composition that comprises “an” additive can be interpreted to mean that the composition includes “one or more” additives.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

Also herein, the recitations of numerical ranges by endpoints include all numbers subsumed within that range (e.g., 1 to 5 includes 1, 1.5, 2, 2.75, 3, 3.80, 4, and 5). Furthermore, disclosure of a range includes disclosure of all subranges included within the broader range (e.g., 1 to 5 discloses 1 to 4, 1.5 to 4.5, and 1 to 2).

Except as otherwise indicated, the term “weight percent” or “wt %” refers to the concentration of a component or composition based on the total weight of the composition, expressed as a percentage.

Except as otherwise indicated, the term “parts by weight” refers to the concentration of a component or composition based on the total weight of the composition.

As used herein, the terms “comprise(s),” “include(s),” “having,” “has,” “contain(s),” and variants thereof, are intended to be open-ended transitional phrases, terms, or words that do not preclude the possibility of additional acts or structure.

The term “component” refers to any part of a composition, polymer or coating that includes a particular feature or structure. Examples of components include compounds, monomers, oligomers, polymers, and organic groups contained there.

As used herein the term “aliphatic” is defined as including alkyl, alkenyl, alkynyl, halogenated alkyl, and cycloalkyl groups as described above. A “lower aliphatic” group is a branched or unbranched aliphatic group having from 1 to 10 carbon atoms.

As used herein the term “alkyl” refers to a branched or unbranched saturated hydrocarbon group of 1 to 24 carbon atoms, such as methyl, ethyl, n-propyl, isopropyl, n-butyl, isobutyl, t-butyl, pentyl, hexyl, heptyl, octyl, decyl, tetradecyl, hexadecyl, eicosyl, tetracosyl, and the like. As used herein a “lower alkyl” group is a saturated branched or unbranched hydrocarbon having from 1 to 10 carbon atoms. In some embodiments, alkyl groups have 1 to 4 carbon atoms may be used. Alkyl groups may be “substituted alkyls” wherein one or more hydrogen atoms are substituted with a substituent such as halogen, cycloalkyl, alkoxy, amino, hydroxyl, aryl, or carboxyl.

As used herein the term “aryl” refers to any carbon-based aromatic group including, but not limited to, phenyl, naphthyl, and other suitable aryl compounds. As used herein the term “aryl” also includes “heteroaryl group,” which is defined as an aromatic group that has at least one heteroatom incorporated within the ring of the aromatic group. Examples of heteroatoms include, but are not limited to, nitrogen, oxygen, sulfur, and phosphorous. The aryl group may be substituted with one or more groups including, but not limited to, alkyl, alkynyl, alkenyl, aryl, halide, nitro, amino, ester, ketone, aldehyde, hydroxy, carboxylic acid, or alkoxy, or the aryl group may be unsubstituted.

As used herein the term “cycloalkyl” refers to a non-aromatic carbon-based ring composed of at least three carbon atoms. Examples of cycloalkyl groups include, but are not limited to, cyclopropyl, cyclobutyl, cyclopentyl, cyclohexyl, and the like. As used herein the term “heterocycloalkyl group” is a cycloalkyl group as defined above in which at least one of the carbon atoms of the ring is substituted with a heteroatom such as, but not limited to, nitrogen, oxygen, sulfur, or phosphorous.

As used herein the term “oligomer” refers to a polyester oligomer that has a weight average absolute molecular weight (Mw) within a range of from about 300 to about 20,000 g/mol as determined by GPC-MALS-DV.

The term “water-based” or “aqueous-based” as used herein may contain or include a solvent containing at least a portion of water, or mostly water. In certain embodiments the term “aqueous-based” may consist of water alone, water and dispersing agents alone, water and catalysts alone, or water and dispersing agents and catalysts. In certain embodiments, the term “aqueous based” may comprise water, additives (e.g., catalyst, dispersing agents, etc.) and co-solvents, such as alcohols. In accordance with certain embodiments, the aqueous-based continuous phase is devoid of co-solvents.

The term “syrup composition” refers to a solution of a solute polyester macromer in one or more solvent monomer mix, the composition having a viscosity of from 500 to 10,000 cPs at room temperature. As used herein, the terms “room temperature” or “ambient temperature” are used interchangeably and refer to temperatures within the range of from about 15° to about 25° C., more typically about 22° C. (72° F.).

The term “solvent-based”, as used herein, refers a composition where one or more components are dissolved or dispersed in a non-aqueous carrier or solvent.

As used herein, the term “liquid at room temperature” means a polymer that undergoes a degree of cold flow at room temperature. Cold flow is the distortion, deformation or dimensional change that takes place in materials under continuous load at temperatures within the working range. Cold flow is not due to heat softening.

The term “(meth)acrylate copolymer” used herein, refers to polymers formed from monomers of acrylates and/or methacrylates or any combination of these in a polymer composition wherein the monomers are esters of acrylic acid or methacrylic acid containing a polymerizable ethylenic linkage. This term also includes other classes of monomers with ethylenic linkage that can copolymerize with acrylate and methacrylate monomers.

As used herein, the term “polymer” may refer to a polymeric compound prepared by polymerizing monomers, whether of the same or a different type. The generic term “polymer” embraces the terms “homopolymer,” “copolymer”, and the like.

As used herein, the term “derived from” or “prepared by the reaction of” or “reaction product of” refers to the polymerization of the said monomers to form the product being referred to. That is, upon polymerization, the monomer, as present in the polymer, is chemically different than the unreacted monomer.

As used herein, the term “inhibitor” refers to a molecule that terminates the growth of free radical polymerization by interacting with the radical terminus of the polymer chain so as to remove its energy for continued reaction with monomer.

As used herein, the term “ethylenically unsaturated” when used to described monomers or groups refers to monomers or groups that contain terminal ethylene groups (H₂C═CH—).

As used herein, the term “cure” refers to polymerize and/or crosslink.

As used here, the term “architecture polymer” or “polymer architecture” in polymer science relates to polymers that are intentionally designed to exhibit characteristics that deviate from a strictly linear polymer chain.

As used herein, the term “melt viscosity” of a polymer at a given temperature is a measure of the rate at which polymer molecules can move relative to each other under shear.

As used herein, the term “intrinsic viscosity [η]” is a measure of a polymer solute's contribution to the viscosity of a solution at a specified temperature.

As used herein, the term “hydrodynamic radius Rh” is the radius of an equivalent sphere representing the mean volume swept out by a randomly moving particle (molecule) in solution.

### II. Crosslinkable Reaction Product

Generally, present subject matter provides a polymer composition comprising, consisting essentially of, or consisting of a crosslinkable reaction product prepared by the reaction of, or copolymerization of, or derived from a mixture comprising, consisting essentially of, or consisting of (1) one or more monomer comprising or consisting of a single polymerizable ethylenically unsaturated bond, wherein the one or more monomer is selected from the group consisting of (meth)acrylate, (meth)acrylamide, non-(meth)acrylate, and combinations thereof, (2) one or more initiator; and (3) a functional agent comprising one or more functional groups, wherein the crosslinkable reaction product comprises a polymer composition selected from the group consisting of a first polymer, a second polymer, and combinations thereof, and wherein any one or more of the following statements or characteristics (A) to (D) applies to the polymer when present in tetrahydrofuran (THF) solution at 30° C. as determined by Gel Permeation Chromatography-Multi-Angle Light Scattering Detection-Differential Viscometry (GPC-MALS-DV):
(A) the polymer exhibits a weight average absolute molecular weight (Mw) of within a range of from about 10,000 to about 10,000,000 g/mol;
(B) the polymer exhibits a polydispersity index (PDI) of less than or equal to about 4.0;
(C) the polymer exhibits an α value of less than about 0.70 calculated according to the Mark-Houwink-Sakurada equation

$$[ η ] = {KM}^{α}$$

wherein,
[η] is an intrinsic viscosity of the polymer of absolute molecular weight M; and
(D) the polymer exhibits a weight average branching ratio g′w value equal to or less than about 0.90 calculated according to the equation

$${g}^{′} w = [ η b ] / η l ]$$

wherein,
[ηb] is the intrinsic viscosity of the polymer and [ηl] is the intrinsic viscosity of a reference linear polymer measured under the same solvent and temperature conditions, both having the same molecular weight (M), the molecular weight determined by GPC-MALS-DV.

In some embodiments, the polymer is as described above and any one or more of the following embodiments (A) to (I) of the polymer, the first polymer, and/or the second polymer are also contemplated herein:
(A) the polymer comprises a non-linear polymer;
(B) the first polymer comprises a polymer selected from the group consisting of a linear polymer, a non-linear polymer, and combinations thereof;
(C) the first polymer comprises a linear polymer;
(D) the first polymer comprises a non-linear polymer;
(E) the first polymer comprises a linear polymer and a non-linear polymer;
(F) the first polymer and the second polymer are non-linear polymers;
(G) the first polymer is less non-linear than the second polymer;
(H) the second polymer comprises a non-linear polymer; and
(I) the non-linear polymers are discrete molecules.

In some embodiments, the polymer is as described above and any one or more of the following embodiments (A) to (F) of the first polymer and/or the second polymer when present in tetrahydrofuran (THF) solution at 30° C. as determined by Gel Permeation Chromatography-Multi-Angle Light Scattering Detection-Differential Viscometry (GPC-MALS-DV) are also contemplated herein;
(A) the first polymer exhibits an α value greater than about 0.50 calculated according to the Mark-Houwink-Sakurada equation

$$[ η ] = {KM}^{α}$$

wherein,
   [η] is an intrinsic viscosity of the first polymer of absolute molecular weight M;
(B) the first polymer exhibits a weight average branching ratio g′w of greater than or equal to about 0.90 calculated according to the equation

$${g}^{′} w = [ η b ] / [ η l ]$$

wherein,
   [ηb] is the intrinsic viscosity of the first polymer and [ηl] is the intrinsic viscosity of a reference linear polymer measured under the same solvent and temperature conditions, both having the same molecular weight (M), the molecular weight determined by GPC-MALS-DV;
(C) the second polymer exhibits an α value of less than about 0.70 calculated according to the Mark-Houwink-Sakurada equation

$$[ η ] = {KM}^{α}$$

wherein,
[η] is an intrinsic viscosity of the polymer of absolute molecular weight M; and
(D) the second polymer exhibits a weight average branching ratio g′w value equal to or less than about 0.90 calculated according to the equation

$${g}^{′} w = [ η b ] / [ η l ]$$

wherein,
[ηb] is the intrinsic viscosity of the second polymer and [ηl] is the intrinsic viscosity of a reference linear polymer measured under the same solvent and temperature conditions, both having the same molecular weight (M), the molecular weight determined by GPC-MALS-DV
(E) the first polymer exhibits an α value greater than the α value of the second polymer; and
(F) the first polymer exhibits a weight average branching ratio g′w greater than the weight average branching ratio g′w value of the second polymer.

In some embodiments, the polymer is as described above and any one or more of the following embodiments (A) to (R) of the first polymer and/or the second polymer when present in tetrahydrofuran (THF) solution at 30° C. as determined by Gel Permeation Chromatography-Multi-Angle Light Scattering Detection-Differential Viscometry (GPC-MALS-DV) are also contemplated herein;
(A) the first polymer exhibits an α value of from equal to or greater than about 0.60 to equal to or less than about 0.75 while the second polymer exhibits an α value of from equal to or greater than about 0.20 to equal to or less than about 0.6;
(B) the first polymer exhibits a weight average branching ratio g′w value of from equal to or greater than about 0.70 to equal to or less than about 1.00 while the second polymer exhibits a weight average branching ratio g′w value of from equal to or greater than about 0.20 to equal to or less than about 0.70;
(C) the first polymer exhibits an α value greater than about 0.70;
(D) the first polymer exhibits an α value greater than 0.60;
(E) the first polymer exhibits an α value greater than 0.50;
(F) the first polymer exhibits an α value of from about 0.70 to about 0.75;
(G) the first polymer exhibits an α value of from about 0.60 to about 0.70;
(H) the first polymer exhibits an α value of from about 0.50 to about 0.60;
(I) the first polymer exhibits a weight average branching ratio g′w of greater than or equal to about 0.80;
(J) the second polymer exhibits an α value less than 0.60;
(K) the second polymer exhibits an α value less than 0.50;
(L) the second polymer exhibits an α value less than 0.40;
(M) the second polymer exhibits an α value less than 0.30;
(N) the second polymer exhibits an α value less than 0.20;
(O) the second polymer exhibits an α value of from about 0.60 to about 0.70;
(P) the second polymer exhibits an α value of from about 0.50 to about 0.60;
(Q) the second polymer exhibits an α value of from about 0.40 to about 0.30; and
(R) the second polymer exhibits an α value of from about 0.30 to about 0.20.

In some embodiments, the polymer is as described above and any one or more of the following embodiments (A) to (E) of the polymer are also contemplated herein:
(A) the polymer comprises a greater wt % of the first polymer than the second polymer based on the total weight of the polymer;
(B) the polymer comprises greater than or equal to 50 wt % of the first polymer;
(C) the polymer comprises greater than or equal to 60 wt % of the first polymer;
(D) the polymer comprises greater than or equal to 70 wt % of the first polymer; and
(E) the polymer comprises greater than or equal to 80 wt % of the first polymer.

In some embodiments, the polymer is as described above and any one or more of the following embodiments (A) to (R) of the polymer when present in tetrahydrofuran (THF) solution at 30° C. as determined by Gel Permeation Chromatography-Multi-Angle Light Scattering Detection-Differential Viscometry (GPC-MALS-DV) are also contemplated herein;
(A) the polymer exhibits a weight average absolute molecular weight (Mw) of greater than about 100,000 g/mol;
(B) the polymer exhibits a weight average absolute molecular weight (Mw) of within a range of from about 100,000 to about 10,000,000 g/mol;
(C) the polymer exhibits a weight average absolute molecular weight (Mw) of greater than about 150,000 g/mol;
(D) the polymer exhibits a weight average absolute molecular weight (Mw) of within a range of from about 150,000 to about 10,000,000 g/mol;
(E) the polymer exhibits a weight average absolute molecular weight (Mw) of greater than about 200,000 g/mol;
(F) the polymer exhibits a weight average absolute molecular weight (Mw) of within a range of from about 200,000 to about 10,000,000 g/mol;
(G) the polymer exhibits a weight average absolute molecular weight (Mw) of greater than about 250,000 g/mol;
(H) the polymer exhibits a weight average absolute molecular weight (Mw) of within a range of from about 250,000 to about 10,000,000 g/mol;
(I) the polymer exhibits a weight average absolute molecular weight (Mw) of greater than about 300,000 g/mol;
(J) the polymer exhibits a weight average absolute molecular weight (Mw) of within a range of from about 350,000 to about 10,000,000 g/mol;
(K) the polymer exhibits a weight average absolute molecular weight (Mw) of greater than about 400,000 g/mol;
(L) the polymer exhibits a weight average absolute molecular weight (Mw) of within a range of from about 400,000 to about 10,000,000 g/mol;
(M) the polymer exhibits a weight average absolute molecular weight (Mw) of greater than about 450,000 g/mol;
(N) the polymer exhibits a weight average absolute molecular weight (Mw) of within a range of from about 450,000 to about 10,000,000 g/mol;
(O) the polymer exhibits a weight average absolute molecular weight (Mw) of greater than about 500,000 g/mol;
(P) the polymer exhibits a weight average absolute molecular weight (Mw) of within a range of from about 500,000 to about 10,000,000 g/mol;
(Q) the polymer exhibits a weight average absolute molecular weight (Mw) of greater than about 550,000 g/mol; and
(R) the polymer exhibits a weight average absolute molecular weight (Mw) of within a range of from about 550,000 to about 10,000,000 g/mol.

The polymer exhibits a weight average absolute molecular weight (Mw) of within a range of from about 10,000 to about 10,000,000 g/mol, including all intermittent values and ranges therein.

In some embodiments, the polymer is as described above and any one or more of the following embodiments (A) to (I) of the polymer when present in tetrahydrofuran (THF) solution at 30° C. as determined by Gel Permeation Chromatography-Multi-Angle Light Scattering Detection-Differential Viscometry (GPC-MALS-DV) are also contemplated herein;
(A) the polymer exhibits a polydispersity index (PDI) of from about 1.1 to less than or equal to about 4.0;
(B) the polymer exhibits a polydispersity index (PDI) of less than or equal to about 3.5;
(C) the polymer exhibits a polydispersity index (PDI) of from about 1.1 to less than or equal to about 3.5;
(D) the polymer exhibits a polydispersity index (PDI) of less than or equal to about 3.0;
(E) the polymer exhibits a polydispersity index (PDI) of from about 1.1 to less than or equal to about 3.0;
(F) the polymer exhibits a polydispersity index (PDI) of less than or equal to about 2.5;
(G) the polymer exhibits a polydispersity index (PDI) of from about 1.1 to less than or equal to about 2.5;
(H) the polymer exhibits a polydispersity index (PDI) of less than or equal to about 2.0; and
(I) the polymer exhibits a polydispersity index (PDI) of from about 1.1 to less than or equal to about 2.0.

In some embodiments, the polymer is as described above and any one or more of the following embodiments (A) to (M) of the first polymer when present in tetrahydrofuran (THF) solution at 30° C. as determined by Gel Permeation Chromatography-Multi-Angle Light Scattering Detection-Differential Viscometry (GPC-MALS-DV) are also contemplated herein;
(A) the first polymer exhibits a weight average absolute molecular weight (Mw) less than a weight average absolute molecular weight (Mw) of the second polymer;
(B) the first polymer exhibits a weight average absolute molecular weight (Mw) greater than or equal to about 100,000 g/mol;
(C) the first polymer exhibits a weight average absolute molecular weight (Mw) of within a range of from about 100,000 to about 5,000,000 g/mol;
(D) the first polymer exhibits a weight average absolute molecular weight (Mw) greater than or equal to about 200,000 g/mol;
(E) the first polymer exhibits a weight average absolute molecular weight (Mw) of within a range of from about 200,000 to about 5,000,000 g/mol;
(F) the first polymer exhibits a weight average absolute molecular weight (Mw) greater than or equal to about 400,000 g/mol;
(G) the first polymer exhibits a weight average absolute molecular weight (Mw) of within a range of from about 400,000 to about 5,000,000 g/mol;
(H) the first polymer exhibits a weight average absolute molecular weight (Mw) greater than or equal to about 500,000 g/mol;
(I) the first polymer exhibits a weight average absolute molecular weight (Mw) of within a range of from about 500,000 to about 5,000,000 g/mol;
(J) the first polymer exhibits a weight average absolute molecular weight (Mw) greater than or equal to about 700,000 g/mol;
(K) the first polymer exhibits a weight average absolute molecular weight (Mw) of within a range of from about 700,000 to about 5,000,000 g/mol;
(L) the first polymer exhibits a weight average absolute molecular weight (Mw) greater than or equal to about 1,000,000 g/mol; and
(M) the first polymer exhibits a weight average absolute molecular weight (Mw) of within a range of from about 1,000,000 to about 5,000,000 g/mol.

The first polymer exhibits a weight average absolute molecular weight (Mw) of within a range of from about 100,000 to about 5,000,000 g/mol, including all intermittent values and ranges therein.

In some embodiments, the polymer is as described above and any one or more of the following embodiments (A) to(S) of the second polymer when present in tetrahydrofuran (THF) solution at 30° C. as determined by Gel Permeation Chromatography-Multi-Angle Light Scattering Detection-Differential Viscometry (GPC-MALS-DV) are also contemplated herein;
(A) the second polymer exhibits a weight average absolute molecular weight (Mw) greater than the weight average absolute molecular weight (Mw) of the polymer;
(B) the second polymer exhibits a weight average absolute molecular weight (Mw) of greater than about 300,000 g/mol;
(C) the second polymer exhibits a weight average absolute molecular weight (Mw) of within a range of from about 300,000 to about 30,000,000 g/mol;
(D) the second polymer exhibits a weight average absolute molecular weight (Mw) of greater than about 600,000 g/mol;
(E) the second polymer exhibits a weight average absolute molecular weight (Mw) of within a range of from about 600,000 to about 30,000,000 g/mol;
(F) the second polymer exhibits a weight average absolute molecular weight (Mw) of greater than about 900,000 g/mol;
(G) the second polymer exhibits a weight average absolute molecular weight (Mw) of within a range of from about 900,000 to about 30,000,000 g/mol;
(H) the second polymer exhibits a weight average absolute molecular weight (Mw) of greater than about 1,200,000 g/mol;
(I) the second polymer exhibits a weight average absolute molecular weight (Mw) of within a range of from about 1,200,000 to about 30,000,000 g/mol;
(J) the second polymer exhibits a weight average absolute molecular weight (Mw) of greater than about 1,500,000 g/mol;
(K) the second polymer exhibits a weight average absolute molecular weight (Mw) of within a range of from about 1,500,000 to about 30,000,000 g/mol;
(L) the second polymer exhibits a weight average absolute molecular weight (Mw) of greater than about 3,000,000 g/mol;
(M) the second polymer exhibits a weight average absolute molecular weight (Mw) of within a range of from about 3,000,000 to about 30,000,000 g/mol;
(N) the second polymer exhibits a weight average absolute molecular weight (Mw) of greater than about 5,000,000 g/mol;
(O) the second polymer exhibits a weight average absolute molecular weight (Mw) of within a range of from about 5,000,000 to about 30,000,000 g/mol;
(P) the second polymer exhibits a weight average absolute molecular weight (Mw) of greater than about 6,000,000 g/mol;
(Q) the second polymer exhibits a weight average absolute molecular weight (Mw) of within a range of from about 6,000,000 to about 30,000,000 g/mol;
(R) the second polymer exhibits a weight average absolute molecular weight (Mw) of greater than about 9,000,000 g/mol; and
(S) the second polymer exhibits a weight average absolute molecular weight (Mw) of within a range of from about 9,000,000 to about 30,000,000 g/mol.

The second polymer exhibits a weight average absolute molecular weight (Mw) of within a range of from about 300,000 to about 30,000,000 g/mol, including all intermittent values and ranges therein.

In some embodiments, the polymer is as described above and any one or more of the following embodiments (A) to (I) of the first and/or the second polymer when present in tetrahydrofuran (THF) solution at 30° C. as determined by Gel Permeation Chromatography-Multi-Angle Light Scattering Detection-Differential Viscometry (GPC-MALS-DV) are also contemplated herein;
(A) the first and second polymer exhibit a polydispersity index (PDI) of from about 1.1 to less than or equal to about 4.0;
(B) the first and/or second polymer exhibit a polydispersity index (PDI) of less than or equal to about 3.5;
(C) the first and/or second polymer exhibit a polydispersity index (PDI) of from about 1.1 to less than or equal to about 3.5;
(D) the first and/or second polymer exhibit a polydispersity index (PDI) of less than or equal to about 3.0;
(E) the first and/or second polymer exhibit a polydispersity index (PDI) of from about 1.1 to less than or equal to about 3.0;
(F) the first and/or second polymer exhibit a polydispersity index (PDI) of less than or equal to about 2.5;
(G) the first and/or second polymer exhibits a polydispersity index (PDI) of from about 1.1 to less than or equal to about 2.5;
(H) the first and/or second polymer exhibit a polydispersity index (PDI) of less than or equal to about 2.0; and
(I) the first and/or second polymer exhibits a polydispersity index (PDI) of from about 1.1 to less than or equal to about 2.0.

In some embodiments, the polymer is as described above and any one or more of the following embodiments (A) to (W) of the post-polymerized polymer at a temperature of about 140° C. as measured with a parallel-plate rheometer are also contemplated herein;
(A) the polymer exhibits a post-polymerization first melt viscosity equal to or greater than about 30,000 cps (30 Pa·s) at a shear rate of about 1.0 s⁻¹;
(B) the polymer exhibits a post-polymerization first melt viscosity equal to or greater than about 40,000 cps (40 Pa·s) at a shear rate of about 1.0 s⁻¹;
(C) the polymer exhibits a post-polymerization first melt viscosity equal to or greater than about 50,000 cps (50 Pa·s) at a shear rate of about 1.0 s⁻¹;
(D) the polymer exhibits a post-polymerization first melt viscosity equal to or greater than about 60,000 cps (60 Pa·s) at a shear rate of about 1.0 s⁻¹;
(E) the polymer exhibits a post-polymerization first melt viscosity equal to or greater than about 70,000 cps (70 Pa·s) at a shear rate of about 1.0 s⁻¹;
(F) the polymer exhibits a post-polymerization first melt viscosity equal to or greater than about 80,000 cps (80 Pa·s) at a shear rate of about 1.0 s⁻¹;
(G) the polymer exhibits a post-polymerization first melt viscosity equal to or greater than about 90,000 cps (90 Pa·s) at a shear rate of about 1.0 s⁻¹;
(H) the polymer exhibits a post-polymerization first melt viscosity equal to or greater than about 100,000 cps (100 Pa·s) at a shear rate of about 1.0 s⁻¹;
(I) the polymer exhibits a post-polymerization first melt viscosity equal to or greater than about 200,000 cps (200 Pa·s) at a shear rate of about 1.0 s⁻¹;
(J) the polymer exhibits a post-polymerization second melt viscosity equal to or greater than about 1,000 cps (1 Pa·s) at a shear rate of about 1000 s⁻¹;
(K) the polymer exhibits a post-polymerization second melt viscosity equal to or greater than about 2,000 cps (2 Pa·s) at a shear rate of about 1000 s⁻¹;
(L) the polymer exhibits a post-polymerization second melt viscosity equal to or greater than about 5,000 cps (5 Pa·s) at a shear rate of about 1000 s⁻¹;
(M) the polymer exhibits a post-polymerization second melt viscosity equal to or greater than about 10,000 cps (10 Pa·s) at a shear rate of about 1000 s⁻¹;
(N) the polymer exhibits a post-polymerization second melt viscosity equal to or greater than about 15,000 cps (15 Pa·s) at a shear rate of about 1000 s⁻¹;
(O) the polymer exhibits a post-polymerization second melt viscosity equal to or greater than about 20,000 cps (20 Pa·s) at a shear rate of about 1000 s⁻¹;
(P) the polymer exhibits a post-polymerization second melt viscosity equal to or greater than about 30,000 cps (30 Pa·s) at a shear rate of about 1000 s⁻¹;
(Q) the polymer exhibits a post-polymerization second melt viscosity equal to or greater than about 40,000 cps (40 Pa·s) at a shear rate of about 1000 s⁻¹;
(R) the polymer exhibits a post-polymerization second melt viscosity equal to or greater than about 50,000 cps (50 Pa·s) at a shear rate of about 1000 s⁻¹;
(S) the polymer exhibits a post-polymerization first melt viscosity within a range of from about 30,000 cps (30 Pa·s) to about 4,000,000 cps (4,000 Pa·s) at a shear rate of about 1.0 s⁻¹ and a second melt viscosity within a range of from about 1,000 cps (1 Pa·s) to about 200,000 cps (200 Pa·s) at a shear rate of about 1000 s⁻¹;
(T) the polymer exhibits a post-polymerization first melt viscosity within a range of from about 30,000 cps (30 Pa·s) to about 4,000,000 cps (4,000 Pa·s) at a shear rate of about 1.0 s⁻¹ and a second melt viscosity within a range of from about 15,000 cps (15 Pa·s) to about 200,000 cps (200 Pa·s) at a shear rate of about 1000 s⁻¹;
(U) the polymer exhibits a post-polymerization first melt viscosity within a range of from about 30,000 cps (30 Pa·s) to about 4,000,000 cps (4,000 Pa·s) at a shear rate of about 1.0 s⁻¹ and a second melt viscosity within a range of from about 40,000 cps (40 Pa·s) to about 200,000 cps (200 Pa·s) at a shear rate of about 1000 s⁻¹;
(V) the polymer exhibits a post-polymerization first melt viscosity within a range of from about 100,000 cps (100 Pa·s) to about 4,000,000 cps (4,000 Pa·s) at a shear rate of about 1.0 s⁻¹ and a second melt viscosity within a range of from about 15,000 cps (15 Pa·s) to about 200,000 cps (200 Pa·s) at a shear rate of about 1000 s″1; and
(W) the polymer exhibits a post-polymerization first melt viscosity within a range of from about 100,000 cps (100 Pa·s) to about 4,000,000 cps (4,000 Pa·s) at a shear rate of about 1.0 s⁻¹ and a second melt viscosity within a range of from about 40,000 cps (40 Pa·s) to about 200,000 cps (200 Pa·s) at a shear rate of about 1000 s⁻¹.

In some embodiments, the polymer is as described above and may be prepared by a free radical polymerization reaction of a mixture comprising or consisting of (1) about 80 to about 99 wt % of the one or more monomer comprising or consisting of a single polymerizable ethylenically unsaturated bond, (2) about 0.001 to about 5 wt % of the one or more initiator; and (3) about 0.001 to about 5 wt % of the functional agent, wherein the weight % of the components sum up to a total of 100% based on the total weight of the polymer.

### A. Monofunctional Monomers

In some embodiments, the polymer is as described above and the mixture that is polymerized to form the polymer described herein comprises or consists of about 80 to about 99 wt % of the one or more monomer comprising a single polymerizable ethylenically unsaturated bond, including all intermittent values and ranges therein, or in the alternative, from about 82 to about 99 wt %, including all intermittent values and ranges therein, or in the alternative, from about 84 to about 99 wt %, including all intermittent values and ranges therein, or in the alternative, from about 86 to about 99 wt %, including all intermittent values and ranges therein, or in the alternative, from about 88 to about 99 wt %, including all intermittent values and ranges therein, or in the alternative, from about 90 to about 99 wt %, including all intermittent values and ranges therein, or in the alternative, from about 92 to about 99 wt %, including all intermittent values and ranges therein, or in the alternative, from about 94 to about 99 wt %, including all intermittent values and ranges therein, or in the alternative, from about 96 to about 99 wt %, including all intermittent values and ranges therein.

In some embodiments, the polymer is as described above and the one or more monomer described above is selected from the group consisting of acrylic acid, acrylates comprising C1 to about C20 alkyl, aryl, aralkyl, or cyclic acrylates, acrylamides comprising C1 to about C20 alkyl, aryl, aralkyl, or cyclic acrylamides, methacrylic acid, methacrylates comprising C1 to about C20 alkyl, aryl, aralkyl, or cyclic methacrylates, methacrylamides comprising C1 to about C20 alkyl, aryl, aralkyl, or cyclic methacrylamides, vinyl monomers, olefins, vinyl aromatics, (meth)acrylated urethanes, (meth)acrylated carbonates, (meth)acrylated esters, (meth)acrylated ethers, vinyl esters, vinyl pyrrolidones, styrenes, and combinations thereof.

In some embodiments, the polymer is as described above and any one or more of the following embodiments (A) to (G) of the one or more monomers are also contemplated herein:
(A) the one or more monomer conversion rate is at least about 90%;
(B) the one or more monomer comprises one or more crosslinkable functional group, wherein the crosslinkable functional group is selected from the group consisting of actinic radiation active functional group, self-reactive functional group, reactive functional group, and combinations thereof;
(C) the actinic radiation active functional group is activatable using actinic radiation or electron beam radiation;
(D) the actinic radiation active functional group is selected from the group consisting of benzophenones, double bonds, and combinations thereof;
(E) the actinic radiation active functional group is selected from the group consisting of acetophenone, an acetophenone derivative, benzophenone, a benzophenone derivative, anthraquinone, an anthraquinone derivative, benzile, a benzile derivative, thioxanthone, a thioxanthone derivative, xanthone, a xanthone derivative, a benzoin ether, a benzoin ether derivative, an alpha-ketol, an alpha-ketol derivative, and combinations thereof;
(F) the reactive functional group is selected from the group consisting of hydroxyl, carboxyl, carbonyl, carbonate ester, isocyanate, epoxy, vinyl, amine, amide, imide, anhydride, mercapto (thiol), acid, acrylamide, acetoacetyl groups, alkoxymethylol, cyclic ether groups, and combinations thereof; and
(G) the self-reactive functional group is selected from the group consisting of silanes, silyl, anhydrides, epoxies, alkoxy-methylol, and cyclic ethers.

### B. Initiators

In some embodiments, the polymer is as described above and the above described mixture that is polymerized to form the polymer described herein comprises or consists of about 0.001 to about 5 wt % of the one or more initiator, including all intermittent values and ranges therein, or in the alternative, from about 0.1 to about 5 wt %, including all intermittent values and ranges therein, or in the alternative, from about 0.5 to about 5 wt %, including all intermittent values and ranges therein, or in the alternative, from about 1.0 to about 5 wt % wt %, including all intermittent values and ranges therein, or in the alternative, from about 1.5 to about 5 wt %, including all intermittent values and ranges therein, or in the alternative, from about 2.0 to about 5 wt %, including all intermittent values and ranges therein, or in the alternative, from about 2.5 to about 5 wt %, including all intermittent values and ranges therein, or in the alternative, from about 3.0 to about 5 wt %, including all intermittent values and ranges therein, or in the alternative, from about 3.5 to about 5 wt %, including all intermittent values and ranges therein, or in the alternative, from about 4.0 to about 5 wt %, including all intermittent values and ranges therein, or in the alternative, from about 4.5 to about 5 wt %, including all intermittent values and ranges therein.

In some embodiments, the polymer is as described above and the one or more initiator is selected from the group consisting of an actinic radiation activatable initiator, an electron beam radiation activatable initiator, a thermally activatable initiator, a redox initiator, an electrochemical initiator, and combinations thereof.

In some embodiments, the polymer is as described above and any one or more of the following embodiments (A) to (N) of the polymerization-initiator and/or the crosslinking-initiator are also contemplated herein:
(A) both the polymerization-initiator and the crosslinking-initiator are actinic radiation activatable initiators;
(B) the polymerization-initiator is activatable at a first activation wavelength(s);
(C) the crosslinking-initiator is activatable at a second activation wavelength(s);
(D) the polymerization-initiator is selectively activatable in the presence of the crosslinking-initiator without activating the crosslinking-initiator;
(E) the polymerization-initiator is selectively activatable in the presence of the crosslinking-initiator without activating the crosslinking-initiator and without the use of an optical filter;
(F) the polymerization-initiator is selectively activatable in the presence of the crosslinking-initiator without activating the crosslinking-initiator and with the use of an optical filter;
(G) the optical filter is selected from the group consisting of absorptive filter, dichroic filter, polychroic filter, notch filter, short pass filter, long pass filter, bandpass filter, multiple band filter (such as a triple band filter), and combinations thereof;
(H) the optical filter is selected from polymeric layers, lenses, films, and combinations thereof;
(I) the polymerization-initiator is substantially non-photoactive at the activation wavelength(s) of the crosslinking-initiator;
(J) the crosslinking-initiator is substantially non-photoactive at the activation wavelength(s) of the polymerization-initiator;
(K) at least one of the polymerization-initiator and the crosslinking-initiator comprises a polymerizable monomer containing a photoinitiator moiety;
(L) the polymerization-initiator is a thermally activatable initiator and the crosslinking-initiator is an actinic radiation activatable initiator;
(M) the polymerization-initiator is an actinic radiation activatable initiator and the crosslinking-initiator is at least one of a thermally activatable initiator and an actinic radiation activatable initiator; and
(N) the polymerization-initiator is at least one of a thermally activatable initiator and an actinic radiation activatable initiator and the crosslinking-initiator is at least one of a thermally activatable initiator and an actinic radiation activatable initiator.

### C. Functional Agents

In some embodiments, the polymer is as described above and the above described mixture that is polymerized to form the polymer described herein comprises or consists of about 0.001 to about 5 wt % of the functional agent, including all intermittent values and ranges therein, or in the alternative, from about 0.1 to about 5 wt %, including all intermittent values and ranges therein, or in the alternative, from about 0.5 to about 5 wt %, including all intermittent values and ranges therein, or in the alternative, from about 1.0 to about 5 wt % wt %, including all intermittent values and ranges therein, or in the alternative, from about 1.5 to about 5 wt %, including all intermittent values and ranges therein, or in the alternative, from about 2.0 to about 5 wt %, including all intermittent values and ranges therein, or in the alternative, from about 2.5 to about 5 wt %, including all intermittent values and ranges therein, or in the alternative, from about 3.0 to about 5 wt %, including all intermittent values and ranges therein, or in the alternative, from about 3.5 to about 5 wt %, including all intermittent values and ranges therein, or in the alternative, from about 4.0 to about 5 wt %, including all intermittent values and ranges therein, or in the alternative, from about 4.5 to about 5 wt %, including all intermittent values and ranges therein.

In some embodiments, the polymer is as described above and any one or more of the following embodiments (A) to (J) of the functional agent are also contemplated herein:
(A) the functional agent is selected from the group consisting of
   (a) a multifunctional initiator,
   (b) a multifunctional chain transfer agent (CTA),
   (c) a multifunctional monomer,
   (d) a linear polymer or a linear oligomer comprising one or more multifunctional initiators chemically bound on the polymer or oligomer backbone, and
   (e) a linear polymer or a linear oligomer comprising/having/containing two or more monofunctional initiators chemically bound on the polymer or oligomer backbone, and combinations thereof;
(B) the functional agent comprises a multifunctional chain transfer agent;
(C) the functional agent comprising three or more functional groups;
(D) other than the functional agent, the mixture does not contain any other monomer comprising two or more polymerizable ethylenic unsaturated bonds (i.e., the formation of this specific embodiment of the controlled non-linear architecture is achieved only via the functional agent which is a stark contrast from prior art whereby random non-linear architecture is achieved via for example both a multifunctional CTA and a multifunctional monomer);
(E) the multifunctional chain transfer agent comprises two or more functional groups, the functional groups having the same or different reactivities;
(F) the multifunctional chain transfer agent comprises a polyvalent mercaptan core comprising three or more thiol (SH) groups, the thiol groups having the same or different reactivities;
(G) the functional agent comprises a polyvalent or polyfunctional atom or molecule (such as halogens, CCl4, etc);
(H) the functional agent comprises a polyvalent or polyfunctional mercaptan;
(I) the functional agent comprises a derivative of a thiocarboxylic acid; and
(J) the functional agent is derived from polythiocarboxylic acids selected from the group consisting of pentaerythritol tetrakis(3-mercaptopropionate) (PEMP), dipentaerythritol Hexakis(3-mercaptopropionate) (DPMP), trimethylolpropane tris(3-mercaptopropionate) (TMMP), and tris[2-(3-mercaptopropionyloxy)ethyl] isocyanurate (TEMPIC), and combinations thereof.

Without being held to any theory, it is believed that the one or more monomers are polymerizable with the functional groups of the functional agent to form (i) a linear polymer (2) a functionalized linear polymer (such as, a comb, brush, or graft polymer), and/or (3) a non-linear polymer. The functionalized linear polymer comprising pendant side-chain polymeric arms attached to a linear polymer backbone (such as a brush, comb, or graft polymer).

### D. Coupling Agent

The above described mixture that is polymerized to form the polymer described herein may further comprise or consist of less than about 0.5 wt % of a coupling agent, or in the alternative from about 0.001 to about 0.5 wt %, including all intermittent values and ranges therein, or in the alternative from about 0.001 to about 0.4 wt %, including all intermittent values, or in the alternative, less than 0.3 wt %, or in the alternative from about 0.001 to about 0.29 wt %, including all intermittent values and ranges therein, or in the alternative, from about 0.01 to about 0.29 wt %, including all intermittent values and ranges therein, or in the alternative, from about 0.1 to about 0.29 wt %, including all intermittent values and ranges therein, or in the alternative, from about 0.15 to about 0.29 wt % wt %, including all intermittent values and ranges therein, or in the alternative, from about 0.20 to about 0.29 wt %, including all intermittent values and ranges therein, or in the alternative, from about 0.25 to about 0.29 wt %, including all intermittent values and ranges therein.

In some embodiments, the polymer is as described above and any one or more of the following embodiments (A) to (J) of the coupling agent are also contemplated herein:
(A) coupling agent comprises a monomer;
(B) the coupling agent comprises at least one polymerizable ethylenic unsaturated bond;
(C) the coupling agent comprises two or more polymerizable ethylenic unsaturated bonds e.g., a divinyl monomer;
(D) the coupling agent is incapable of participating in a free radical polymerization reaction;
(E) the coupling agent comprises a functional group capable of reacting under non-free radical conditions in a condensation reaction;
(F) the coupling agent is capable of participating in a free radical process;
(G) the coupling agent comprises a cationic polymerizable group;
(H) the coupling agent comprises a vinyl ether group;
(I) the coupling agent is capable of a thiol-ene reaction;
(J) the coupling agent is selected from the group consisting of divinyl ether, diisocyanate, multifunctional (meth)acrylates, difunctional (meth)acrylates, aliphatic divinyl compounds, such as hexa-1,5-diene, hepta-1,6-diene, ethylene glycol dimethacrylate, methylene di(meth)acrylate and ethylene divinylurea; aromatic divinyl compounds such as divinylbenzene, methyldivinylbenzene, divinyltoluene, divinylbiphenyl, diallyl phthalate, and divinylnaphthalene; polyvalent ethylene glycol di(meth)acrylates such as ethylene glycol di(meth)acrylate, diethylene glycol di(meth)acrylate, triethylene glycol di(meth)acrylate and tetraethylene glycol di(meth)acrylate; polyvalent propylene glycol di(meth)acrylates such as propylene glycol di(meth)acrylate and dipropyleneethylene glycol di(meth)acrylate; di(meth)acrylate compounds such as 1,2-butanediol di(meth)acrylate, 1,3-butanediol di(meth)acrylate, 1,4-butanediol di(meth)acrylate, 1,5-pentanediol di(meth)acrylate, 1,6-hexanediol di(meth)acrylate, 1,9-nonanediol di(meth)acrylate, 1,10-decanediol di(meth)acrylate, 2-methyl-1,8-octanediol (meth)acrylate and 1,4-cyclohexanediol dimethacrylate, and the like; carboxylic acid esters having two double bonds such as ethylene glycol diacrylate, ethylene glycol dimethacrylate and the like; divinyl compounds such as divinyl ether, divinyl sulfite, divinyl sulfone, N,N′-Methylenebisacrylamide, and combinations thereof.

Without being held to any theory, it is believed that the coupling agent is capable of covalently linking each one of the cores of a portion of the polymer to other one or more cores to form at least one of a chain polymer structure such as a pom-pom and/or a multidimensional network structure thus significantly increasing the molecular weight of resulting polymer.

### E. Multifunctional Agent

The above described mixture that is polymerized to form the polymer described herein may further comprise or consist of less than 0.5 wt % of a multifunctional agent, or in the alternative, from about 0.001 to about 0.5 wt %, including all intermittent values and ranges therein, or in the alternative from about 0.001 to about 0.4 wt %, including all intermittent values, or in the alternative, less than 0.3 wt %, or in the alternative or in the alternative, from about 0.001 to about 0.29 wt %, including all intermittent values and ranges therein, or in the alternative, from about 0.01 to about 0.29 wt %, including all intermittent values and ranges therein, or in the alternative, from about 0.1 to about 0.29 wt %, including all intermittent values and ranges therein, or in the alternative, from about 0.15 to about 0.29 wt % wt %, including all intermittent values and ranges therein, or in the alternative, from about 0.20 to about 0.29 wt %, including all intermittent values and ranges therein, or in the alternative, from about 0.25 to about 0.29 wt %, including all intermittent values and ranges therein.

In some embodiments, the polymer is as described above and any one or more of the following embodiments (A) to (K) of the multifunctional agent are also contemplated herein:
(A) the one or more multifunctional agent is a monomer;
(B) the one or more multifunctional agent is chemically bound to backbone of the polymer;
(C) the one or more multifunctional agent comprises at least one ethylenic unsaturated bond;
(D) the one or more multifunctional agent comprises two or more ethylenic unsaturated bonds;
(E) the one or more multifunctional agent comprises at least one of ethylenic unsaturation and acrylate unsaturation;
(F) the one or more multifunctional agent comprises a functional group capable of reacting under non-free radical conditions in a condensation reaction
(G) the one or more multifunctional agent is capable of a thiol-ene reaction;
(H) the one or more multifunctional agent comprises at least one radical polymerizable group and at least one cationic polymerizable group in one molecule;
(I) the one or more multifunctional agent comprises at least one (meth)acryloyl group and at least one vinylether group in one molecule;
(J) the one or more multifunctional agent may be represented by the following formula (I):

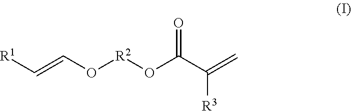

where R¹ is selected from hydrogen; aliphatic C₁₋₆ alkyl; and C₁₋₆ cycloalkyl; R² is selected from C₂₋₂₀ alkylene; C₂₋₂₀ hydrocarbon diradical; and polyalkylene oxide; and R³ is selected from hydrogen and methyl;
(K) the one or more multifunctional agent is selected from the group consisting of multifunctional (meth)acrylate, allyl (meth)acrylate, vinyl ether (meth)acrylate, alpha olefin maleic anhydride (AOMA), 2-(2-vinyloxyethoxy)ethyl acrylate (VEEA), 2-(2′-vinyloxyethoxy)ethyl methacrylate (VEEM), 2-vinyloxyethyl acrylate, 2-vinyloxyethyl methacrylate, 2-(2′-prop-1-2-(2′-prop-1-enyloxyethoxy)ethyl acrylate, and enyloxyethoxy)ethyl methacrylate, combinations thereof.

Without being held to any theory, it is believed that the molecular weight of the polymer described above may be significantly increased via the following reactions;
(1) one or more multifunctional agent may be polymerizable (via the (meth)acrylate groups) with the one or more monomers (e.g., via a free radical polymerization reaction) to form one of more pendant side-chains attached to a functionalized linear polymer backbone, wherein each of the one or more pendant side-chain contains a vinyl group. The vinyl groups of the one or more pendant side-chains may be capable of reacting with at least one of the functional groups of the functional agent to form one or more non-linear polymers, wherein the one or more non-linear polymers comprises the one or more pendant side-chains covalently attached to the functionalized linear polymer backbone and
(2) the one or more multifunctional agent may be polymerizable (via the vinyl groups) with at least one of the functional groups of the functional agent (e.g., via a thiol-ene reaction) to form one or more multifunctional chain transfer agents, wherein each of the one or more multifunctional chain transfer agents contains a (meth)acrylate group. The one or more multifunctional chain transfer agents may be polymerizable (via the (meth)acrylate groups) with the one or more monomers to form one or more pendant side chains, wherein the one or more pendant side chains are covalently attached to a functionalized linear polymer backbone to form a non-linear polymer.

The resulting non-linear polymer may comprise at least one of a comb polymer/structure, a brush polymer/structure, and a graft polymer/structure.

In some embodiments, the polymer is as described above and the composition may further comprise or consist of ring-opening monomers selected from the group consisting of epoxies, oxetanes, anhydrides, lactones, lactams, cyclic ethers and cyclic siloxanes, and combinations thereof and cationically polymerizable monomers selected from the group consisting of epoxy-containing materials, alkyl vinyl ethers, cyclic ethers, styrene, divinyl benzene, vinyl toluene, N-vinyl compounds, cyanate esters, 1-alkyl olefins (alpha olefins), lactams and cyclic acetals, and combinations thereof.

In some embodiments, the polymer is as described above and the composition may further comprise or consist of at least one component selected from the group consisting of pigments, tackifiers, plasticizers, fillers, diluents, inhibitors, and combinations thereof.

In some embodiments, the polymer is as described above and any one or more of the following embodiments (A) to (F) of the above described mixture that is polymerized to form the polymer described herein are also contemplated herein:
(A) the mixture further comprises a non-reactive carrier;
(B) the mixture is free of a non-reactive carrier;
(C) the non-reactive carrier is unreactive with the functional groups of the components of the mixture;
(D) the non-reactive carrier 7 is selected from the group consisting of an organic solvent, water, and combinations thereof;
(E) the organic solvent is selected from the group consisting of aromatic hydrocarbon, alkyl ester, cycloaliphatic hydrocarbon, aliphatic hydrocarbon, ketone, amines, amides, esters, ethers, aliphatic ester, alcohol, nitrated hydrocarbon, unsaturated hydrocarbon, chlorinated hydrocarbon, and combinations thereof; and
(F) the mixture has a pre-polymerization viscosity of from about 2 cps to about 50 cps at room temperature.

In some embodiments, the polymer is as described above and any one or more of the following embodiments (A) to (G) of the free radical polymerization reaction described above are also contemplated herein:
(A) the reaction is a solvent polymerization reaction;
(B) the reaction is a non-solution process;
(C) the reaction is an emulsion polymerization reaction;
(D) the reaction is a bulk polymerization reaction;
(E) the reaction is a suspension polymerization reaction;
(F) the reaction is a one-step process; and
(G) the reaction is a two-step process. For example, a linear polymer or a linear oligomer comprising one or more multifunctional initiators chemically bound on the polymer or oligomer backbone or a comprising two or more monofunctional initiators chemically bound on the polymer or oligomer backbone may be subjected to a further polymerization or modification step to form a non-linear polymer.

In some embodiments, the polymer is as described above and any one or more of the following embodiments (A) to (J) of the polymer are also contemplated herein:
(A) the polymer is soluble in a non-reactive carrier;
(B) the conversion of monomers to the polymer is greater than 90%;
(C) the polymer exhibits a multimodal molecular weight distribution determined by GPC-MALS-DV;
(D) the polymer is 100% solids;
(E) the polymer is ungelled (gel-free);
(F) the polymer exhibits a unimodal molecular weight distribution determined by GPC-MALS-DV;
(G) the polymer exhibits a multimodal molecular weight distribution determined by GPC-MALS-DV;
(H) the polymer exhibits a glass transition temperature (Tg) of from about 100° C. to about −115° C. as determined by differential scanning calorimetry (DSC);
(I) the polymer exhibits a single glass transition temperature (Tg) within from about 100° C. to about −115° C. as determined by differential scanning calorimetry (DSC); and
(J) the polymer exhibits two or more glass transition temperatures (Tg) within from about 100° C. to about −115° C. as determined by differential scanning calorimetry (DSC).

### III. Crosslinked Reaction Product

In some embodiments, the polymer described above may be at least partially crosslinked via at least one of actinic radiation, electron beam radiation, heating, moisture, or metal-based ionic crosslinking to form an adhesive.

In some embodiment, the polymer is as described above and upon at least partially crosslinking exhibits any one or more of the following embodiments (A) to (C) which are also contemplated herein:
(A) the polymer is at least partially crosslinked to form an adhesive;
(B) the polymer is at least partially crosslinked to form an adhesive exhibiting a plateau shear modulus at 25° C. and 1 radian per second that is between 10⁴ and 10⁷ dynes/cm² as determined by dynamic mechanical analysis (DMA); and
(C) the polymer is at least partially crosslinked to form a pressure sensitive adhesive;

In some embodiment, the polymer is as described above and the at least partially crosslinking is performed of the polymer is performed by heating the composition.

In some embodiment, the polymer is as described above and the at least partially crosslinking is performed via metal based ionic crosslinking.

In some embodiment, the polymer is as described above and the at least partially crosslinking is performed by exposing the composition to actinic radiation or electron beam radiation.

A pressure sensitive adhesive comprising the polymer described above is also contemplated herein.

According to what has come to be known as the Dahlquist criteria, to perform as a pressure sensitive adhesive, the formulation must have a plateau shear modulus at 25° C. and 1 radian per second that is between 5×10⁴ and 6×10⁶ dynes/cm² as determined by dynamic mechanical analysis. A material having plateau shear modulus greater than 1×10⁷ dynes/cm² at 25° C. will be too stiff to exhibit tack at room temperature to be useful as pressure sensitive adhesive. A material with plateau shear modulus less than 1×10⁴ dynes/cm² at 25° C. will lack sufficient cohesive strength to be useful as pressure sensitive adhesive. Representative and non-limiting examples of ranges of the DSC measured glass transition temperatures (Tg) for the pressure sensitive adhesives of the instant subject matter are from about 10° C. to about −60° C., or from about 0° C. to about −40° C., and/or from about −10° C. to about −40° C.

A polymer blend comprising the first and second polymer as described above and as described in any one of claims 1-26 is also contemplated herein.

An article comprising the adhesive described above is also contemplated herein.

In some embodiment, the article further comprises a substrate defining a face;
wherein the adhesive is directly coatable on at least a portion of the face of the substrate and does not require a primer disposed in between the adhesive and the substrate.

In some embodiment, the substrate is heat sensitive (i.e., deteriorates, melts, bends, or bubbles) at temperatures above about 110° C., wherein the substrate is selected from the group consisting of polypropylene, polyethylene, and vinyl, and wherein the polyethylene is selected from the group consisting of linear density polyethylene (LDPE), linear low density polyethylene (LDPE), medium density polyethylene (MDPE), high density polyethylene (HDPE), ultra-high molecular weight polyethylene (UHMWPE), and combinations thereof.

In some embodiment, the article further comprises a substrate defining a face;
wherein the adhesive is coatable on a carrier or release liner before transferring it to the substrate, and wherein the carrier is selected from the group consisting of silicone-coated paper, polyethylene film, polyester film, glassine paper, polycoated Kraft paper, fluoropolymer film, release-coated fabrics, thermoplastic films, polypropylene films, release-coated foils, and polyvinyl chloride chloride (PVC) films.

In some embodiments, a method of forming a composition comprising a crosslinkable polymer as described above is contemplated. The method comprises the steps of (1) providing the mixture of ingredients as described in any one of claims 1 to 26, (2) polymerizing the mixture via a free radical polymerization reaction to form the polymer described in any one of claims 1 to 26.

In some embodiments, the polymerizing step comprises heating the mixture.

In some embodiments, the polymerizing step comprises exposing the mixture to actinic radiation or electron beam radiation.

In some embodiments, the polymerizing step is performed in one step.

In some embodiments, the polymerizing step is performed in two or more steps.

The method further comprises the step of (3) crosslinking the polymer to form an adhesive, wherein the crosslinking is activatable by at least one of actinic radiation, electron beam radiation, heating, moisture, or metal-based ionic crosslinking.

In some embodiments, the adhesive exhibits a plateau shear modulus at 25° C. and 1 radian per second that is between 10⁴ and 10⁷ dynes/cm² as determined by dynamic mechanical analysis (DMA).

In some embodiments, the adhesive is a pressure sensitive adhesive.

In some embodiments, the present subject matter provides a polymer composition comprising, consisting essentially of, or consisting of a crosslinkable reaction product prepared by the reaction of, or copolymerization of, or derived from a mixture comprising, consisting essentially of, or consisting of (1) one or more monomer comprising or consisting of a single polymerizable ethylenically unsaturated bond, wherein the one or more monomer is selected from the group consisting of (meth)acrylate, (meth)acrylamide, non-(meth)acrylate, and combinations thereof, (2) one or more initiator; and (3) a functional agent comprising two or more functional groups, wherein any one or more of the following statements (A) to (C) applies:
(A) a weight average hydrodynamic radius of a molecule of the crosslinkable reaction product in tetrahydrofuran (THF) solution at 30° C. of less than about 30 nm at a weight average absolute molecular weight (Mw) of about 1,500,000 g/mol or less as determined by Gel Permeation Chromatography-Multi-Angle Light Scattering Detection-Differential Viscometry (GPC-MALS-DV);
(B) an intrinsic viscosity of the crosslinkable reaction product in THE solution at 30° C. of about 1.0 dL/g or less at a weight average absolute molecular weight (Mw) of about 1,500,000 g/mol or less as determined by GPC-MALS-DV; and
(C) the crosslinkable reaction product exhibits a post-polymerization melt viscosity within a range of from 90,000 cps to 7,000,000 cps at a shear rate of about 0.25 s 1 at a temperature of about 110° C. as measured a parallel-plate rheometer.

### EXAMPLES

The present disclosure is further illustrated by the following example, which in no way should be construed as being limiting. That is, the specific features described in the following examples are merely illustrative, and not limiting.

### Example 1

A monomer mixture was prepared with 1.8 grams of allyl methacrylate, 579.2 grams of butyl acrylate, 10.3 grams of Avery Dennison's proprietary monomer 001, 6.9 grams of pentaerythritol tetrakis(3-mercaptopropionate) and 117.1 grams of ethyl acetate and then purged with continuous nitrogen flow. Separately, an initiator solution was prepared with 0.096 grams of t-amyl peroxypivalate and 159.7 grams of ethyl acetate. Into a glass reactor equipped with a reflux condenser, a thermocouple, a nitrogen inlet and a pitched turbine agitator set at 150 RPM, there was charged 143.0 grams of the monomer mixture above, 119.6 grams of ethyl acetate. After 30 minutes of nitrogen sparge, the batch was heated to 80° C. to which was added a solution of 0.027 grams of t-amyl peroxypivalate in 5.5 grams of ethyl acetate. After 5 minutes, the remaining monomer mixture was added to the reactor at a rate of 4.8 gram/min while simultaneously the initiator solution was introduced into the reactor at a rate of 0.9 gram/min. The batch temperature was maintained between 80 to 85° C. After the initiator solution was fed into the reactor, the batch was maintained at 80 to 85° C. for 2 hours. The contents were then cooled to ambient temperature and discharged. The polymer was then subjected to characterization as described below.

### Example 2

A monomer mixture was prepared with 25.0 grams of acrylic acid, 469.8 grams of butyl acrylate, 2.9 grams of Avery Dennison's proprietary monomer 001 and 334.9 grams of ethyl acetate and then purged with continuous nitrogen flow. Separately, an initiator solution was prepared with 0.096 grams of t-amyl peroxypivalate in 40.0 grams of ethyl acetate and then divided into 8 equal aliquots. Into a glass reactor equipped with a reflux condenser, a thermocouple, a nitrogen inlet and a pitched turbine agitator set at 150 RPM, there was charged 166.5 grams of the monomer mixture above, 119.6 grams of ethyl acetate and 2.3 grams of dipentaerythritol hexakis (3-mercaptopropionate). After 30 minutes of nitrogen sparge, the batch was heated to 80° C. to which was added a solution of 0.027 grams of t-amyl peroxypivalate in 5.5 grams of ethyl acetate. After 5 minutes, the remaining monomer mixture was added to the reactor at a rate of 5.6 gram/min while the initiator solution aliquot was introduced into the reactor every 30 minutes afterwards. The batch temperature was maintained between 80 to 85° C. After all the initiator solution aliquots were fed into the reactor, the batch was maintained at 80 to 85° C. for 1 hour. The contents were then cooled to ambient temperature and discharged. The polymer was then subjected to characterization as described below.

### Example 3

A monomer mixture was prepared with 25.0 grams of acrylic acid, 463.5 grams of butyl acrylate, 5.7 grams of Avery Dennison's proprietary monomer 001 and 264.2 grams of ethyl acetate and then purged with continuous nitrogen flow. Separately, an initiator solution was prepared with 0.45 grams of Vazo® 64 and 112.1 grams of ethyl acetate. Into a glass reactor equipped with a reflux condenser, a thermocouple, a nitrogen inlet and a pitched turbine agitator set at 150 RPM, there was charged 151.7 grams of the monomer mixture above, 118.7 grams of ethyl acetate, 1.0 gram of allyl methacrylate and 3.9 grams of pentaerythritol tetrakis(3-mercaptopropionate). After 30 minutes of nitrogen sparge, the batch was heated to 70° C. and a solution of 0.47 grams of Vazo® 64 in 5.0 grams of ethyl acetate was added. After 5 minutes, the remaining monomer mixture was added to the reactor at a rate of 5.1 gram/min while simultaneously the initiator solution was introduced into the reactor at a rate of 0.75 gram/min. The batch temperature was maintained between 80 to 85° C. After the initiator solution was fed into the reactor, the batch was maintained at 80 to 85° C. for 2 hours. The contents were then cooled to ambient temperature and discharged. The polymer was then subjected to characterization as described below.

### Example 4

A monomer mixture was prepared with 25.0 grams of acrylic acid, 470.6 grams of butyl acrylate, 2.9 grams of Avery Dennison's proprietary monomer 001 and 215.8 grams of ethyl acetate and then purged with continuous nitrogen flow. Separately, an initiator solution was prepared with 0.096 grams of t-amyl peroxypivalate and 159.7 grams of ethyl acetate. Into a glass reactor equipped with a reflux condenser, a thermocouple, a nitrogen inlet and a pitched turbine agitator set at 150 RPM, there was charged 142.9 grams of the monomer mixture above, 119.6 grams of ethyl acetate, and 0.87 grams of dipentaerythritol hexakis (3-mercaptopropionate). After 30 minutes of nitrogen sparge, the batch was heated to 80° C. to which was added a solution of 0.027 grams of t-amyl peroxypivalate in 5.5 grams of ethyl acetate. After 5 minutes, the remaining monomer mixture was added to the reactor at a rate of 4.8 gram/min while simultaneously the initiator solution was introduced into the reactor at a rate of 0.89 gram/min. The batch temperature was maintained between 80 to 85° C. After the initiator solution was fed into the reactor, the batch was maintained at 80 to 85° C. for 2 hours. The contents were then cooled to ambient temperature and discharged. The polymer was then subjected to characterization as described below.

### Control

H-505, an acrylic UV crosslinkable warm melt pressure sensitive adhesive, is commercially available from the Avery Dennison Performance Polymers Division.

### Characterization

Molecular weight distribution moments, weight-average absolute molecular weight (Mw), polydispersity index (PDI=M_{w}/Mₙ, M_{w} is the weight average molecular weight and Mₙ is the number average molecular weight), Rh(v)w (weight average hydrodynamic radius), and intrinsic viscosity ([η]) were determined using Wyatt Dawn Multi-Angle Light Scattering (MALS) and Viscostar Differential Viscometry detectors linked to an Agilent 1260 GPC system with an Agilent differential refractive index concentration detector. Absolute molecular weight (M) and polymer radius of gyration, <Rg>, were calculated using MALS response with either the Zimm plot formalism for <Rg> less than 40 nm or the Berry plot formalism for <Rg> greater than 40 nm.

Mark-Houwink-Sakurada equation, [η]=KM^{α} correlations were used to observe the relationship between intrinsic viscosity and absolute molecular weight (M), with the Alpha (α) exponent determined from regression analysis. Log-Log Mark-Houwink-Sakurada plots were evaluated with linear regression correlation to observe uniform polymer chain architecture. When changes in the linear slope were observed, the distribution was segmented into high molecular weight (High M) and low molecular weight (Low M) linear regions to observe uniform branching ratio values.

The weight-average branching ratio g′_{w} is defined as the ratio of the intrinsic viscosity of the (nonlinear) material ([η]_{br}) to that of its linear analog ([η]ₗᵢₙ) of the same molecular weight, g′w=([η]_{br}/[η]ₗᵢₙ)_{M}. Therefore, g′_{w} equals 1.0 for a linear polymer of similar chemical composition while g′_{w} less than 1.0 represents a non-linear polymer. For experimental polymer samples with molecular weights exceeding that of the linear reference polymer of similar monomer composition, linear model extrapolations were used to calculate [η]ₗᵢₙ from the K and alpha coefficients determined for the linear reference polymer.

Gel Permeation Chromatography (GPC) separations were performed on a three-column set of Agilent Mixed-C 5 micron, 7.5×300 mm columns at 30° C. with 1.0 ml/min of BHT stabilized HPLC grade tetrahydrofuran (THF). Polymer samples were prepared at 5.0 mg/ml in THF and filtered through 0.2 micron PTFE syringe filters before injection of 100 microliter aliquots.

Unless noted, all the samples are otherwise gel-free polymers where polymer gels are defined as cross-linked polymer networks that are swollen but not soluble in solvents.

Wyatt MALS instrumental calibration coefficients were determined with 30 k Da narrow dispersity polystyrene. Polymer refractive index increment (dn/dc) was measured using a concentration series of a neat copolymer in THF at 30° C. using the differential refractive index detector response relative to a known value for a polystyrene standard (0.185 mL/g).

The Rheological tests were performed using a DHR-2 Rheometer (TA Instruments, Waters) equipped with a 8 mm parallel plates fixture. Frequency sweeps were carried out at various temperatures under a nitrogen environment in order to build a master curve at 140° C. using the Time Temperature Superposition Principle. Any skilled/trained workers can run the test. The Cox-Merz Rule was used to convert the complex viscosity versus angular frequency curve to shear viscosity versus shear rates curve. The viscosities of the samples at two different shear rates, 1 s⁻¹ and 1000 s⁻¹ were reported.

Table 1 below shows the molecular characteristics and physical properties of the subject matter as prepared in Example 1-4 in comparison to the control:

TABLE 1
Molecular characteristics and physical properties of Example 1-4

| | Example 1 | Example 2 | Example 3 | Example 4 | Control |
|---|---|---|---|---|---|
| M_{w} (Kg/mol) | 82 | 488 | 677 | 944 | 162 |
| [η] (dL/g) | 0.23 | 0.44 | 0.38 | 0.78 | 0.27 |
| Rh(v)w (nm) | 6.8 | 17.7 | 18.0 | 25.2 | 10.6 |
| PDI | 2.0 | 3.1 | 3.7 | 2.8 | 2.7 |
| Melt viscosity at 140° C., | 38.8 | 916.1 | 197.2 | 3445.4 | 90.2 |
| 1 s⁻¹ (Pa · s) | | | | | |
| Melt viscosity at 140° C., | 2.3 | 47.9 | 21.0 | 66.9 | 24.9 |
| 1000 s⁻¹ (Pa · s) | | | | | |

M_{w} = whole sample weight-average absolute molecular weight; PDI = whole sample polydispersity index M_{w}/Mₙ, [η] = whole sample average intrinsic viscosity; Rh(v)w = whole sample weight-average hydrodynamic radius.

The molecular characteristics of each individual polymer segment of high molecular weight (High M) and/or low molecular weight (Low M), present in the Example 1-4 are described in Table 2 below:

TABLE 2
Molecular characteristics of Example 1-4 with
polymer segments of different molecular weight

| | Example 1 | Example 2 | Example 3 | Example 4 | Control |
|---|---|---|---|---|---|
| Alpha (α) High M | 0.61 | 0.38 | 0.38 | 0.43 | 0.70 |
| Alpha (α) Low M | | 0.67 | 0.69 | 0.66 | |
| g′_{w} High M | 0.88 | 0.59 | 0.35 | 0.62 | 1.0 |
| g′_{w} Low M | | 0.86 | 0.74 | 0.88 | |
| M_{w} (Kg/mol) High M | 82 | 1580 | 1300 | 3200 | 162 |
| M_{w} (Kg/mol) Low M | | 290 | 147 | 478 | |
| Rh(v)w (nm) High M | 6.8 | 36.4 | 28.2 | 52.4 | 10.6 |
| Rh(v)w (nm) Low M | | 14.4 | 9.6 | 19.4 | |
| PDI High M | 2.0 | 1.2 | 1.8 | 1.3 | 2.7 |
| PDI Low M | | 2.0 | 1.3 | 1.7 | |
| [η] (dL/g) High M | 0.23 | 1.8 | 0.95 | 2.7 | 0.27 |
| [η] (dL/g) Low M | | 0.46 | 0.33 | 0.76 | |

M_{w} = weight-average absolute molecular weight; PDI = polydispersity index M_{w}/Mₙ, [η] = average intrinsic viscosity; Rh(v)w = weight-average hydrodynamic radius, Alpha (α) = Mark-Houwink-Sakurada exponent; g′_{w} = ([η]_{br}/[η]ₗᵢₙ)_{M}, weight-average intrinsic viscosity branching ratio.

The subject matter in Example 1 consists of only one polymer segment as the control does while the subject matter in Example 2-4 consists of at least two polymer segments of different molecular weight and characteristics.

### Pressure Sensitive Adhesion Testing

For pressure sensitive adhesion performance characterization, each polymer solution was directly coated onto a 50 micron thick MYLAR® release liner at a dry coat weight of 55 g/m² (grams per square meter), dried at 120° C. for 5 minutes, crosslinked with a UV-C dosage of 10-13 mJ/cm² and then transferred to a 2 mil thick MYLAR® film.

180° Peel adhesion values were measured in lb/inch at 12 inch/minute crosshead speed after the specified dwell time (i.e., 20 minutes or 24 hours) on stainless steel panels. Static shear values (i.e., time durations in minutes until failure) were also measured on stainless steel panels at room temperature using 1 inch×1 inch contact area with 1000 gram weight. All tests were performed in a controlled environment room of 22° C. and 50% relative humidity.

The pressure sensitive adhesion performance of the adhesive samples prepared from Examples 2, 3 and 4 are presented in Table 3 below, which consists of 180° peel adhesion and static shear, in comparison to the control.

TABLE 3
Adhesion Performance of Example 2, 3, 4 and the Control

| | 180° Peel, | 180° Peel, | |
|---|---|---|---|
| | 20 minute dwell | 24 hour dwell | Static Shear |
| Sample | (lb/inch) | (lb/inch) | (minutes) |
| Example 2 | 4.3** | 4.4** | >6000 |
| Example 3 | 4.4** | 5.0** | >2500 |
| Example 4 | 3.9** | 4.0** | >10000 |
| Control | 13.0* | 13.0* | <30 |

*Cohesive failure mode;
**Adhesive failure mode;

The subject matter, illustrated by Example 2, 3 and 4 of similar monomer composition as that of the control, clearly outperforms the control in pressure sensitive adhesion with well-balanced peel-shear performance.

The features, structures, or characteristics of the invention described throughout this specification may be combined in any suitable manner in one or more aspects. For example, reference throughout this specification to “certain aspects,” “some aspects,” or similar language means that a particular feature, structure, or characteristic described in connection with the aspect is included in at least one aspect of the present invention. Thus, appearances of the phrases “in certain aspects,” “in some aspect,” “in other aspects,” or similar language throughout this specification do not necessarily all refer to the same group of aspects and the described features, structures, or characteristics may be combined in any suitable manner in one or more aspects.

As described hereinabove, the present subject matter solves many problems associated with previous strategies, systems and/or devices. However, it will be appreciated that various changes in the details, materials and arrangements of components and/or operations, which have been herein described and illustrated in order to explain the nature of the present subject matter, may be made by those skilled in the art without departing from the principle and scope of the claimed subject matter, as expressed in the appended claims.

1. A composition comprising a crosslinkable reaction product of a mixture, the mixture comprising:
one or more monomer comprising a single polymerizable ethylenically unsaturated bond, wherein the one or more monomer is selected from the group consisting of (meth)acrylate, (meth)acrylamide, non-(meth)acrylate, and combinations thereof;
one or more initiator; and
a functional agent comprising one or more functional groups;
wherein the crosslinkable reaction product comprises a polymer composition selected from the group consisting of a first polymer, a second polymer, and combinations thereof; and
wherein any one or more of the following statements (A) to (D) applies to the polymer when present in tetrahydrofuran (THF) solution at 30° C. as determined by Gel Permeation Chromatography-Multi-Angle Light Scattering Detection-Differential Viscometry (GPC-MALS-DV):
(A) the polymer exhibits a weight average absolute molecular weight (Mw) of within a range of from about 10,000 to about 10,000,000 g/mol;
(B) the polymer exhibits a polydispersity index (PDI) of less than or equal to about 4.0;
(C) the polymer exhibits an α value of less than about 0.70 calculated according to the Mark-Houwink-Sakurada equation
$$[ η ] = {KM}^{α}$$
wherein,
[η] is an intrinsic viscosity of the polymer of absolute molecular weight M;
(D) the polymer exhibits a weight average branching ratio g′w value equal to or less than about 0.90 calculated according to the equation
$${g}^{′} w = [ η b ] / [ η l ]$$
wherein,
[ηb] is the intrinsic viscosity of the polymer and [ηl] is the intrinsic viscosity of a reference linear polymer measured under the same solvent and temperature conditions, both having the same molecular weight (M), the molecular weight determined by GPC-MALS-DV.

2. The composition of claim 1, wherein any one or more of the following statements (A) to (I) applies:
(A) the polymer comprises a non-linear polymer;
(B) the first polymer comprises a polymer selected from the group consisting of a linear polymer, a non-linear polymer, and combinations thereof;
(C) the first polymer comprises a linear polymer;
(D) the first polymer comprises a non-linear polymer;
(E) the first polymer comprises a linear polymer and a non-linear polymer;
(F) the first polymer and the second polymer are non-linear polymers;
(G) the first polymer is less non-linear than the second polymer;
(H) the second polymer comprises a non-linear polymer; and
(I) the non-linear polymers are discrete molecules.

3. The composition of claim 1, wherein any one or more of the following statements (A) to (F) applies to the first polymer and/or the second polymer when present in tetrahydrofuran (THF) solution at 30° C. as determined by Gel Permeation Chromatography-Multi-Angle Light Scattering Detection-Differential Viscometry (GPC-MALS-DV):
(A) the first polymer exhibits an α value greater than about 0.50 calculated according to the Mark-Houwink-Sakurada equation
$$[ η ] = {KM}^{α}$$
wherein,
[η] is an intrinsic viscosity of the first polymer of absolute molecular weight M;
(B) the first polymer exhibits a weight average branching ratio g′w of greater than or equal to about 0.90 calculated according to the equation
$${g}^{′} w = [ η b ] / [ η l ]$$
wherein,
[ηb] is the intrinsic viscosity of the first polymer and [ηl] is the intrinsic viscosity of a reference linear polymer measured under the same solvent and temperature conditions, both having the same molecular weight (M), the molecular weight determined by GPC-MALS-DV;
(C) the second polymer exhibits an α value of less than about 0.70 calculated according to the Mark-Houwink-Sakurada equation
$$[ η ] = {KM}^{α}$$
wherein,
[η] is an intrinsic viscosity of the polymer of absolute molecular weight M; and
(D) the second polymer exhibits a weight average branching ratio g′w value equal to or less than about 0.90 calculated according to the equation
$${g}^{′} w = [ η b ] / [ η l ]$$
wherein,
[ηb] is the intrinsic viscosity of the second polymer and [ηl] is the intrinsic viscosity of a reference linear polymer measured under the same solvent and temperature conditions, both having the same molecular weight (M), the molecular weight determined by GPC-MALS-DV
(E) the first polymer exhibits an α value greater than the α value of the second polymer; and
(F) the first polymer exhibits a weight average branching ratio g′w greater than the weight average branching ratio g′w value of the second polymer.

4. The composition of claim 1, wherein any one or more of the following statements (A) to (R) applies to the first polymer and/or the second polymer when present in tetrahydrofuran (THF) solution at 30° C. as determined by Gel Permeation Chromatography-Multi-Angle Light Scattering Detection-Differential Viscometry (GPC-MALS-DV):
(A) the first polymer exhibits an α value of from equal to or greater than about 0.60 to equal to or less than about 0.75 while the second polymer exhibits an α value of from equal to or greater than about 0.20 to equal to or less than about 0.6;
(B) the first polymer exhibits a weight average branching ratio g′w value of from equal to or greater than about 0.70 to equal to or less than about 1.00 while the second polymer exhibits a weight average branching ratio g′w value of from equal to or greater than about 0.20 to equal to or less than about 0.70;
(C) the first polymer exhibits an α value greater than about 0.70;
(D) the first polymer exhibits an α value greater than about 0.60;
(E) the first polymer exhibits an α value greater than about 0.50;
(F) the first polymer exhibits an α value of from about 0.70 to about 0.75;
(G) the first polymer exhibits an α value of from about 0.60 to about 0.70;
(H) the first polymer exhibits an α value of from about 0.50 to about 0.60;
(I) the first polymer exhibits a weight average branching ratio g′w of greater than or equal to about 0.80;
(J) the second polymer exhibits an α value less than about 0.60;
(K) the second polymer exhibits an α value less than about 0.50;
(L) the second polymer exhibits an α value less than about 0.40;
(M) the second polymer exhibits an α value less than about 0.30;
(N) the second polymer exhibits an α value less than about 0.20;
(O) the second polymer exhibits an α value of from about 0.60 to about 0.70;
(P) the second polymer exhibits an α value of from about 0.50 to about 0.60;
(Q) the second polymer exhibits an α value of from about 0.40 to about 0.30; and
(R) the second polymer exhibits an α value of from about 0.30 to about 0.20.

5. The composition of claim 1, wherein any one or more of the following statements (A) to (E) applies:
(A) the polymer comprises a greater wt % of the first polymer than the second polymer based on the total weight of the polymer;
(B) the polymer comprises greater than or equal to 50 wt % of the first polymer;
(C) the polymer comprises greater than or equal to 60 wt % of the first polymer;
(D) the polymer comprises greater than or equal to 70 wt % of the first polymer; and
(E) the polymer comprises greater than or equal to 80 wt % of the first polymer.

6. The composition of claim 1, wherein any one or more of the following statements (A) to (R) applies to the polymer in tetrahydrofuran (THF) solution at 30° C. as determined by Gel Permeation Chromatography-Multi-Angle Light Scattering Detection-Differential Viscometry (GPC-MALS-DV):
(A) the polymer exhibits a weight average absolute molecular weight (Mw) of greater than about 100,000 g/mol;
(B) the polymer exhibits a weight average absolute molecular weight (Mw) of within a range of from about 100,000 to about 10,000,000 g/mol;
(C) the polymer exhibits a weight average absolute molecular weight (Mw) of greater than about 150,000 g/mol;
(D) the polymer exhibits a weight average absolute molecular weight (Mw) of within a range of from about 150,000 to about 10,000,000 g/mol;
(E) the polymer exhibits a weight average absolute molecular weight (Mw) of greater than about 200,000 g/mol;
(F) the polymer exhibits a weight average absolute molecular weight (Mw) of within a range of from about 200,000 to about 10,000,000 g/mol;
(G) the polymer exhibits a weight average absolute molecular weight (Mw) of greater than about 250,000 g/mol;
(H) the polymer exhibits a weight average absolute molecular weight (Mw) of within a range of from about 250,000 to about 10,000,000 g/mol;
(I) the polymer exhibits a weight average absolute molecular weight (Mw) of greater than about 300,000 g/mol;
(J) the polymer exhibits a weight average absolute molecular weight (Mw) of within a range of from about 350,000 to about 10,000,000 g/mol;
(K) the polymer exhibits a weight average absolute molecular weight (Mw) of greater than about 400,000 g/mol;
(L) the polymer exhibits a weight average absolute molecular weight (Mw) of within a range of from about 400,000 to about 10,000,000 g/mol;
(M) the polymer exhibits a weight average absolute molecular weight (Mw) of greater than about 450,000 g/mol;
(N) the polymer exhibits a weight average absolute molecular weight (Mw) of within a range of from about 450,000 to about 10,000,000 g/mol;
(O) the polymer exhibits a weight average absolute molecular weight (Mw) of greater than about 500,000 g/mol;
(P) the polymer exhibits a weight average absolute molecular weight (Mw) of within a range of from about 500,000 to about 10,000,000 g/mol;
(Q) the polymer exhibits a weight average absolute molecular weight (Mw) of greater than about 550,000 g/mol; and
(R) the polymer exhibits a weight average absolute molecular weight (Mw) of within a range of from about 550,000 to about 10,000,000 g/mol;

7. The composition of claim 1, wherein any one or more of the following statements (A) to (I) applies to the polymer in tetrahydrofuran (THF) solution at 30° C. as determined by Gel Permeation Chromatography-Multi-Angle Light Scattering Detection-Differential Viscometry (GPC-MALS-DV):
(A) the polymer exhibits a polydispersity index (PDI) of from about 1.1 to less than or equal to about 4.0;
(B) the polymer exhibits a polydispersity index (PDI) of less than or equal to about 3.5;
(C) the polymer exhibits a polydispersity index (PDI) of from about 1.1 to less than or equal to about 3.5;
(D) the polymer exhibits a polydispersity index (PDI) of less than or equal to about 3.0;
(E) the polymer exhibits a polydispersity index (PDI) of from about 1.1 to less than or equal to about 3.0;
(F) the polymer exhibits a polydispersity index (PDI) of less than or equal to about 2.5;
(G) the polymer exhibits a polydispersity index (PDI) of from about 1.1 to less than or equal to about 2.5;
(H) the polymer exhibits a polydispersity index (PDI) of less than or equal to about 2.0; and
(I) the polymer exhibits a polydispersity index (PDI) of from about 1.1 to less than or equal to about 2.0.

8. The composition of claim 1, wherein any one or more of the following statements (A) to (M) applies to the first polymer when present in tetrahydrofuran (THF) solution at 30° C. as determined by Gel Permeation Chromatography-Multi-Angle Light Scattering Detection-Differential Viscometry (GPC-MALS-DV):
(A) the first polymer exhibits a weight average absolute molecular weight (Mw) less than a weight average absolute molecular weight (Mw) of the second polymer;
(B) the first polymer exhibits a weight average absolute molecular weight (Mw) greater than or equal to about 100,000 g/mol;
(C) the first polymer exhibits a weight average absolute molecular weight (Mw) of within a range of from about 100,000 to about 5,000,000 g/mol;
(D) the first polymer exhibits a weight average absolute molecular weight (Mw) greater than or equal to about 200,000 g/mol;
(E) the first polymer exhibits a weight average absolute molecular weight (Mw) of within a range of from about 200,000 to about 5,000,000 g/mol;
(F) the first polymer exhibits a weight average absolute molecular weight (Mw) greater than or equal to about 400,000 g/mol;
(G) the first polymer exhibits a weight average absolute molecular weight (Mw) of within a range of from about 400,000 to about 5,000,000 g/mol;
(H) the first polymer exhibits a weight average absolute molecular weight (Mw) greater than or equal to about 500,000 g/mol;
(I) the first polymer exhibits a weight average absolute molecular weight (Mw) of within a range of from about 500,000 to about 5,000,000 g/mol;
(J) the first polymer exhibits a weight average absolute molecular weight (Mw) greater than or equal to about 700,000 g/mol;
(K) the first polymer exhibits a weight average absolute molecular weight (Mw) of within a range of from about 700,000 to about 5,000,000 g/mol;
(L) the first polymer exhibits a weight average absolute molecular weight (Mw) greater than or equal to about 1,000,000 g/mol; and
(M) the first polymer exhibits a weight average absolute molecular weight (Mw) of within a range of from about 1,000,000 to about 5,000,000 g/mol.

9. The composition of claim 1, wherein any one or more of the following statements (A) to(S) applies to the second polymer when present in tetrahydrofuran (THF) solution at 30° C. as determined by Gel Permeation Chromatography-Multi-Angle Light Scattering Detection-Differential Viscometry (GPC-MALS-DV):
(A) the second polymer exhibits a weight average absolute molecular weight (Mw) greater than the weight average absolute molecular weight (Mw) of the polymer;
(B) the second polymer exhibits a weight average absolute molecular weight (Mw) of greater than about 300,000 g/mol;
(C) the second polymer exhibits a weight average absolute molecular weight (Mw) of within a range of from about 300,000 to about 30,000,000 g/mol;
(D) the second polymer exhibits a weight average absolute molecular weight (Mw) of greater than about 600,000 g/mol;
(E) the second polymer exhibits a weight average absolute molecular weight (Mw) of within a range of from about 600,000 to about 30,000,000 g/mol;
(F) the second polymer exhibits a weight average absolute molecular weight (Mw) of greater than about 900,000 g/mol;
(G) the second polymer exhibits a weight average absolute molecular weight (Mw) of within a range of from about 900,000 to about 30,000,000 g/mol;
(H) the second polymer exhibits a weight average absolute molecular weight (Mw) of greater than about 1,200,000 g/mol;
(I) the second polymer exhibits a weight average absolute molecular weight (Mw) of within a range of from about 1,200,000 to about 30,000,000 g/mol;
(J) the second polymer exhibits a weight average absolute molecular weight (Mw) of greater than about 1,500,000 g/mol;
(K) the second polymer exhibits a weight average absolute molecular weight (Mw) of within a range of from about 1,500,000 to about 30,000,000 g/mol;
(L) the second polymer exhibits a weight average absolute molecular weight (Mw) of greater than about 3,000,000 g/mol;
(M) the second polymer exhibits a weight average absolute molecular weight (Mw) of within a range of from about 3,000,000 to about 30,000,000 g/mol;
(N) the second polymer exhibits a weight average absolute molecular weight (Mw) of greater than about 5,000,000 g/mol;
(O) the second polymer exhibits a weight average absolute molecular weight (Mw) of within a range of from about 5,000,000 to about 30,000,000 g/mol;
(P) the second polymer exhibits a weight average absolute molecular weight (Mw) of greater than about 6,000,000 g/mol;
(Q) the second polymer exhibits a weight average absolute molecular weight (Mw) of within a range of from about 6,000,000 to about 30,000,000 g/mol;
(R) the second polymer exhibits a weight average absolute molecular weight (Mw) of greater than about 9,000,000 g/mol; and
(S) the second polymer exhibits a weight average absolute molecular weight (Mw) of within a range of from about 9,000,000 to about 30,000,000 g/mol.

10. The composition of claim 1, wherein any one or more of the following statements (A) to (I) applies to the polymer in tetrahydrofuran (THF) solution at 30° C. as determined by Gel Permeation Chromatography-Multi-Angle Light Scattering Detection-Differential Viscometry (GPC-MALS-DV):
(A) the first and/or second polymer exhibit a polydispersity index (PDI) of from about 1.1 to less than or equal to about 4.0;
(B) the first and/or second polymer exhibit a polydispersity index (PDI) of less than or equal to about 3.5;
(C) the first and/or second polymer exhibit a polydispersity index (PDI) of from about 1.1 to less than or equal to about 3.5;
(D) the first and/or second polymer exhibit a polydispersity index (PDI) of less than or equal to about 3.0;
(E) the first and/or second polymer exhibit a polydispersity index (PDI) of from about 1.1 to less than or equal to about 3.0;
(F) the first and/or second polymer exhibit a polydispersity index (PDI) of less than or equal to about 2.5;
(G) the first and/or second polymer exhibits a polydispersity index (PDI) of from about 1.1 to less than or equal to about 2.5;
(H) the first and/or second polymer exhibit a polydispersity index (PDI) of less than or equal to about 2.0; and
(I) the first and/or second polymer exhibits a polydispersity index (PDI) of from about 1.1 to less than or equal to about 2.0.

11. The composition of claim 1, wherein any one or more of the following statements (A) to (W) applies to the post-polymerization polymer at a temperature of about 140° C. as measured with a parallel-plate rheometer:
(A) the polymer exhibits a post-polymerization first melt viscosity equal to or greater than about 30,000 cps (30 Pa·s) at a shear rate of about 1.0 s⁻¹;
(B) the polymer exhibits a post-polymerization first melt viscosity equal to or greater than about 40,000 cps (40 Pa·s) at a shear rate of about 1.0 s⁻¹;
(C) the polymer exhibits a post-polymerization first melt viscosity equal to or greater than about 50,000 cps (50 Pa·s) at a shear rate of about 1.0 s⁻¹;
(D) the polymer exhibits a post-polymerization first melt viscosity equal to or greater than about 60,000 cps (60 Pa·s) at a shear rate of about 1.0 s⁻¹;
(E) the polymer exhibits a post-polymerization first melt viscosity equal to or greater than about 70,000 cps (70 Pa·s) at a shear rate of about 1.0 s⁻¹;
(F) the polymer exhibits a post-polymerization first melt viscosity equal to or greater than about 80,000 cps (80 Pa·s) at a shear rate of about 1.0 s⁻¹;
(G) the polymer exhibits a post-polymerization first melt viscosity equal to or greater than about 90,000 cps (90 Pa·s) at a shear rate of about 1.0 s⁻¹;
(H) the polymer exhibits a post-polymerization first melt viscosity equal to or greater than about 100,000 cps (100 Pa·s) at a shear rate of about 1.0 s⁻¹;
(I) the polymer exhibits a post-polymerization first melt viscosity equal to or greater than about 200,000 cps (200 Pa·s) at a shear rate of about 1.0 s⁻¹;
(J) the polymer exhibits a post-polymerization second melt viscosity equal to or greater than about 1,000 cps (1 Pa·s) at a shear rate of about 1000 s⁻¹;
(K) the polymer exhibits a post-polymerization second melt viscosity equal to or greater than about 2,000 cps (2 Pa·s) at a shear rate of about 1000 s⁻¹;
(L) the polymer exhibits a post-polymerization second melt viscosity equal to or greater than about 5,000 cps (5 Pa·s) at a shear rate of about 1000 s⁻¹;
(M) the polymer exhibits a post-polymerization second melt viscosity equal to or greater than about 10,000 cps (10 Pa·s) at a shear rate of about 1000 s⁻¹;
(N) the polymer exhibits a post-polymerization second melt viscosity equal to or greater than about 15,000 cps (15 Pa·s) at a shear rate of about 1000 s⁻¹;
(O) the polymer exhibits a post-polymerization second melt viscosity equal to or greater than about 20,000 cps (20 Pa·s) at a shear rate of about 1000 s⁻¹;
(P) the polymer exhibits a post-polymerization second melt viscosity equal to or greater than about 30,000 cps (30 Pa·s) at a shear rate of about 1000 s⁻¹;
(Q) the polymer exhibits a post-polymerization second melt viscosity equal to or greater than about 40,000 cps (40 Pa·s) at a shear rate of about 1000 s⁻¹;
(R) the polymer exhibits a post-polymerization second melt viscosity equal to or greater than about 50,000 cps (50 Pa·s) at a shear rate of about 1000 s⁻¹;
(S) the polymer exhibits a post-polymerization first melt viscosity within a range of from about 30,000 cps (30 Pa·s) to about 4,000,000 cps (4,000 Pa·s) at a shear rate of about 1.0 s⁻¹ and a second melt viscosity within a range of from about 1,000 cps (1 Pa·s) to about 200,000 cps (200 Pa·s) at a shear rate of about 1000 s⁻¹;
(T) the polymer exhibits a post-polymerization first melt viscosity within a range of from about 30,000 cps (30 Pa·s) to about 4,000,000 cps (4,000 Pa·s) at a shear rate of about 1.0 s⁻¹ and a second melt viscosity within a range of from about 15,000 cps (15 Pa·s) to about 200,000 cps (200 Pa·s) at a shear rate of about 1000 s⁻¹;
(U) the polymer exhibits a post-polymerization first melt viscosity within a range of from about 30,000 cps (30 Pa·s) to about 4,000,000 cps (4,000 Pa·s) at a shear rate of about 1.0 s⁻¹ and a second melt viscosity within a range of from about 40,000 cps (40 Pa·s) to about 200,000 cps (200 Pa·s) at a shear rate of about 1000 s⁻¹;
(V) the polymer exhibits a post-polymerization first melt viscosity within a range of from about 100,000 cps (100 Pa·s) to about 4,000,000 cps (4,000 Pa·s) at a shear rate of about 1.0 s″ and a second melt viscosity within a range of from about 15,000 cps (15 Pa·s) to about 200,000 cps (200 Pa·s) at a shear rate of about 1000 s⁻¹; and
(W) the polymer exhibits a post-polymerization first melt viscosity within a range of from about 100,000 cps (100 Pa·s) to about 4,000,000 cps (4,000 Pa·s) at a shear rate of about 1.0 s⁻¹ and a second melt viscosity within a range of from about 40,000 cps (40 Pa·s) to about 200,000 cps (200 Pa·s) at a shear rate of about 1000 s⁻¹.

12. The composition of claim 1, wherein the mixture comprises:
about 80 to about 99 wt % of the one or more monomer comprising a single polymerizable ethylenically unsaturated bond;
about 0.001 to about 5 wt % of the one or more initiator; and
about 0.001 to about 5 wt % of the functional agent, wherein the weight % of the components sum up to a total of 100% based on the total weight of the polymer.

13. The composition of claim 1, wherein the one or more monomer are selected from the group consisting of acrylic acid, acrylates comprising C1 to about C20 alkyl, aryl, aralkyl, or cyclic acrylates, acrylamides comprising C1 to about C20 alkyl, aryl, aralkyl, or cyclic acrylamides, methacrylic acid, methacrylates comprising C1 to about C20 alkyl, aryl, aralkyl, or cyclic methacrylates, methacrylamides comprising C1 to about C20 alkyl, aryl, aralkyl, or cyclic methacrylamides, vinyl monomers, olefins, vinyl aromatics, (meth)acrylated urethanes, (meth)acrylated carbonates, (meth)acrylated esters, (meth)acrylated ethers, vinyl esters, vinyl pyrrolidones, styrenes, and combinations thereof.

14. The composition of claim 1, wherein any one or more of the following statements (A) to (G) applies:
(A) the one or more monomer conversion rate is at least about 90%;
(B) the one or more monomer further comprises one or more crosslinkable functional group, wherein the crosslinkable functional group is selected from the group consisting of actinic radiation active functional group, self-reactive functional group, reactive functional group, and combinations thereof;
(C) the actinic radiation active functional group is activatable using actinic radiation or electron beam radiation;
(D) the actinic radiation active functional group is selected from the group consisting of benzophenones, double bonds, and combinations thereof;
(E) the actinic radiation active functional group is selected from the group consisting of acetophenone, an acetophenone derivative, benzophenone, a benzophenone derivative, anthraquinone, an anthraquinone derivative, benzile, a benzile derivative, thioxanthone, a thioxanthone derivative, xanthone, a xanthone derivative, a benzoin ether, a benzoin ether derivative, an alpha-ketol, an alpha-ketol derivative, and combinations thereof;
(F) the reactive functional group is selected from the group consisting of hydroxyl, carboxyl, carbonyl, carbonate ester, isocyanate, epoxy, vinyl, amine, amide, imide, anhydride, mercapto (thiol), acid, acrylamide, acetoacetyl groups, alkoxymethylol, cyclic ether groups, and combinations thereof; and
(G) the self-reactive functional group is selected from the group consisting of silanes, silyl, anhydrides, epoxies, alkoxy-methylol, and cyclic ethers.

15. The composition of claim 1, wherein the one or more initiator is selected from the group consisting of an actinic radiation activatable initiator, an electron beam radiation activatable initiator, a thermally activatable initiator, a redox initiator, an electrochemical initiator, and combinations thereof.

16. The composition of claim 1, wherein the one or more initiator comprises at least one polymerization-initiator and at least one crosslinking-initiator and any one or more of the following statements (A) to (N) applies:
(A) both the polymerization-initiator and the crosslinking-initiator are actinic radiation activatable initiators;
(B) the polymerization-initiator is activatable at a first activation wavelength(s);
(C) the crosslinking-initiator is activatable at a second activation wavelength(s);
(D) the polymerization-initiator is selectively activatable in the presence of the crosslinking-initiator without activating the crosslinking-initiator;
(E) the polymerization-initiator is selectively activatable in the presence of the crosslinking-initiator without activating the crosslinking-initiator and without the use of an optical filter;
(F) the polymerization-initiator is selectively activatable in the presence of the crosslinking-initiator without activating the crosslinking-initiator and with the use of an optical filter;
(G) the optical filter is selected from the group consisting of absorptive filter, dichroic filter, polychroic filter, notch filter, short pass filter, long pass filter, bandpass filter, multiple band filter (e.g. triple band filter), and combinations thereof;
(H) the optical filter is selected from polymeric layers, lenses, films, and combinations thereof;
(I) the polymerization-initiator is substantially non-photoactive at the activation wavelength(s) of the crosslinking-initiator;
(J) the crosslinking-initiator is substantially non-photoactive at the activation wavelength(s) of the polymerization-initiator;
(K) at least one of the polymerization-initiator and the crosslinking-initiator comprises a polymerizable monomer containing a photoinitiator moiety;
(L) the polymerization-initiator is a thermally activatable initiator and the crosslinking-initiator is an actinic radiation activatable initiator;
(M) the polymerization-initiator is an actinic radiation activatable initiator and the crosslinking-initiator is at least one of a thermally activatable initiator and an actinic radiation activatable initiator; and
(N) the polymerization-initiator is at least one of a thermally activatable initiator and an actinic radiation activatable initiator and the crosslinking-initiator is at least one of a thermally activatable initiator and an actinic radiation activatable initiator.

17. The composition of claim 1, wherein any one or more of the following statements (A) to (K) applies:
(A) the functional agent is selected from the group consisting of
(a) a multifunctional initiator,
(b) a multifunctional chain transfer agent,
(c) a multifunctional monomer,
(d) a linear polymer or a linear oligomer comprising one or more multifunctional initiators chemically bound on the polymer or oligomer backbone, and
(e) a linear polymer or a linear oligomer comprising/having/containing two or more monofunctional initiators chemically bound on the polymer or oligomer backbone, and combinations thereof;
(B) the functional agent comprises a multifunctional chain transfer agent;
(C) the functional agent comprising two or more functional groups;
(D) the functional agent comprises three or more functional groups;
(E) other than the functional agent, the mixture does not contain any other monomer comprising two or more polymerizable ethylenic unsaturated bonds;
(F) the multifunctional chain transfer agent comprises two or more functional groups, the functional groups having the same or different reactivities;
(G) the multifunctional chain transfer agent comprises a polyvalent mercaptan core comprising three or more thiol (SH) groups, the thiol groups having the same or different reactivities;
(H) the functional agent comprises a polyvalent or polyfunctional atom or molecule;
(I) the functional agent comprises a polyvalent or polyfunctional mercaptan;
(J) the functional agent comprises a derivative of a thiocarboxylic acid; and
(K) the functional agent is derived from polythiocarboxylic acids selected from the group consisting of pentaerythritol tetrakis(3-mercaptopropionate) (PEMP), dipentaerythritol Hexakis(3-mercaptopropionate) (DPMP), trimethylolpropane tris(3-mercaptopropionate) (TMMP), and tris[2-(3-mercaptopropionyloxy)ethyl] isocyanurate (TEMPIC), and combinations thereof.

18. The composition of claim 1, wherein the mixture further comprises a coupling agent.

19. The composition of claim 18, wherein any one or more of the following statements (A) to (M) applies:
(A) the mixture comprises less than 0.5 wt % of the coupling agent;
(B) the mixture comprises less than 0.3 wt % of the coupling agent;
(C) the mixture comprises about 0.001 to about 0.29 wt % of the coupling agent;
(D) the coupling agent comprises a monomer;
(E) the coupling agent comprises at least one polymerizable ethylenic unsaturated bond;
(F) the coupling agent comprises two or more polymerizable ethylenic unsaturated bonds;
(G) the coupling agent is incapable of participating in a free radical polymerization reaction;
(H) the coupling agent comprises a functional group capable of reacting under non-free radical conditions in a condensation reaction;
(I) the coupling agent is capable of participating in a free radical process;
(J) the coupling agent comprises a cationic polymerizable group;
(K) the coupling agent comprises a vinyl ether group;
(L) the coupling agent is capable of a thiol-ene reaction;
(M) the coupling agent is selected from the group consisting of divinyl ether, diisocyanate, multifunctional (meth)acrylates, difunctional (meth)acrylates, aliphatic divinyl compounds, such as hexa-1,5-diene, hepta-1,6-diene, ethylene glycol dimethacrylate, methylene di(meth)acrylate and ethylene divinylurea; aromatic divinyl compounds such as divinylbenzene, methyldivinylbenzene, divinyltoluene, divinylbiphenyl, diallyl phthalate, and divinylnaphthalene; polyvalent ethylene glycol di(meth)acrylates such as ethylene glycol di(meth)acrylate, diethylene glycol di(meth)acrylate, triethylene glycol di(meth)acrylate and tetraethylene glycol di(meth)acrylate; polyvalent propylene glycol di(meth)acrylates such as propylene glycol di(meth)acrylate and dipropyleneethylene glycol di(meth)acrylate; di(meth)acrylate compounds such as 1,2-butanediol di(meth)acrylate, 1,3-butanediol di(meth)acrylate, 1,4-butanediol di(meth)acrylate, 1,5-pentanediol di(meth)acrylate, 1,6-hexanediol di(meth)acrylate, 1,9-nonanediol di(meth)acrylate, 1,10-decanediol di(meth)acrylate, 2-methyl-1,8-octanediol (meth)acrylate and 1,4-cyclohexanediol dimethacrylate, and the like; carboxylic acid esters having two double bonds such as ethylene glycol diacrylate, ethylene glycol dimethacrylate and the like; divinyl compounds such as divinyl ether, divinyl sulfite, divinyl sulfone, N,N′-Methylenebisacrylamide, and the like

20. The composition of claim 1, wherein the mixture further comprises a multifunctional agent.

21. The composition of claim 20, wherein any one or more of the following statements (A) to (N) applies:
(A) the mixture comprises less than 0.5 wt % of the multifunctional agent;
(B) the mixture comprises less than 0.3 wt % of the multifunctional agent;
(C) the mixture comprises 0.001 to less than 0.3 wt % of the multifunctional agent;
(D) the multifunctional agent is a monomer;
(E) the multifunctional agent is chemically bound to the backbone of the polymer;
(F) the multifunctional agent comprises at least one ethylenic unsaturated bond;
(G) the multifunctional agent comprises two or more ethylenic unsaturated bonds;
(H) the multifunctional agent comprises at least one of ethylenic unsaturation and acrylate unsaturation;
(I) the multifunctional agent comprises a functional group capable of reacting under non-free radical conditions in a condensation reaction
(J) the multifunctional agent is capable of a thiol-ene reaction;
(K) the multifunctional agent comprises at least one radical polymerizable group and at least one cationic polymerizable group in one molecule;
(L) the multifunctional agent comprises at least one (meth)acryloyl group and at least one vinylether group in one molecule;
(M) the multifunctional agent is represented by the following formula (I): 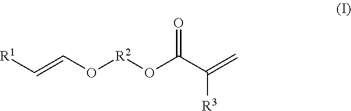
where R¹ is selected from hydrogen; aliphatic C₁₋₆ alkyl; and C₁₋₆ cycloalkyl; R² is selected from C₂₋₂₀ alkylene; C₂₋₂₀ hydrocarbon diradical; and polyalkylene oxide; and R³ is selected from hydrogen and methyl; and
(N) the multifunctional agent is selected from the group consisting of multifunctional (meth)acrylate, allyl (meth)acrylate, vinyl ether (meth)acrylate, alpha olefin maleic anhydride (AOMA), 2-(2-vinyloxyethoxy)ethyl acrylate (VEEA), 2-(2′-vinyloxyethoxy)ethyl methacrylate (VEEM), 2-vinyloxyethyl acrylate, 2-vinyloxyethyl methacrylate, 2-(2′-prop-1-enyloxyethoxy)ethyl methacrylate, 2-(2′-prop-1-enyloxyethoxy)ethyl acrylate, and combinations thereof.

22. The composition of claim 1, wherein any one or more of the following statements (A) to (F) applies:
(A) the mixture further comprises a non-reactive carrier;
(B) the mixture is free of a non-reactive carrier;
(C) the non-reactive carrier is unreactive with the functional groups of the components of the mixture;
(D) the non-reactive carrier is selected from the group consisting of an organic solvent, water, and combinations thereof;
(E) the organic solvent is selected from the group consisting of aromatic hydrocarbon, alkyl ester, cycloaliphatic hydrocarbon, aliphatic hydrocarbon, ketone, amines, amides, esters, ethers, aliphatic ester, alcohol, nitrated hydrocarbon, unsaturated hydrocarbon, chlorinated hydrocarbon, and combinations thereof; and
(F) the mixture has a pre-polymerization viscosity of from about 2 cps to about 50 cps at room temperature.

23. The composition of claim 1, wherein any one or more of the following statements (A) to (B) applies:
(A) the composition further comprises ring-opening monomers selected from the group consisting of epoxies, oxetanes, anhydrides, lactones, lactams, cyclic ethers and cyclic siloxanes, and combinations thereof and cationically polymerizable monomers selected from the group consisting of epoxy-containing materials, alkyl vinyl ethers, cyclic ethers, styrene, divinyl benzene, vinyl toluene, N-vinyl compounds, cyanate esters, 1-alkyl olefins (alpha olefins), lactams and cyclic acetals, and combinations thereof; and
(B) the composition further comprises at least one component selected from the group consisting of pigments, tackifiers, plasticizers, fillers, diluents, inhibitors, and combinations thereof.

24. The composition of claim 1, wherein any one or more of the following statements (A) to (G) applies:
(A) the reaction is a solvent polymerization reaction;
(B) the reaction is a non-solution process;
(C) the reaction is an emulsion polymerization reaction;
(D) the reaction is a bulk polymerization reaction;
(E) the reaction is a suspension polymerization reaction;
(F) the reaction is a one-step process; and
(G) the reaction is a two-step or more process.

25. The composition of claim 1, wherein any one or more of the following statements (A) to (I) applies:
(A) the polymer is soluble in a non-reactive carrier;
(B) the conversion of monomers to the polymer is greater than 90%;
(C) the polymer is 100% solids;
(D) the polymer is ungelled (gel-free);
(E) the polymer exhibits a unimodal molecular weight distribution determined by GPC-MALS-DV;
(F) the polymer exhibits a multimodal molecular weight distribution determined by GPC-MALS-DV;
(G) the polymer exhibits a glass transition temperature (Tg) of from about 100° C. to about-115° C. as determined by differential scanning calorimetry (DSC);
(H) the polymer exhibits a single glass transition temperature (Tg) within from about 100° C. to about −115° C. as determined by differential scanning calorimetry (DSC); and
(I) the polymer exhibits two or more glass transition temperatures (Tg) within from about 100° C. to about −115° C. as determined by differential scanning calorimetry (DSC).

26. The composition of claim 1, wherein the reaction is a free radical polymerization reaction.

27. The composition of claim 1, wherein the polymer upon at least partially crosslinking exhibits any one or more of the following statements (A) to (G) applies:
(A) the polymer is at least partially crosslinked to form an adhesive;
(B) the polymer is at least partially crosslinked to form an adhesive exhibiting a plateau shear modulus at 25° C. and 1 radian per second that is between 10⁴ and 10⁷ dynes/cm² as determined by dynamic mechanical analysis (DMA);
(C) the polymer is at least partially crosslinked to form a pressure sensitive adhesive;
(D) the at least partially crosslinking is performed using at least one of actinic radiation, electron beam radiation, heating, moisture, or metal-based ionic crosslinking;
(E) the at least partially crosslinking of the polymer is performed by heating the composition;
(F) the at least partially crosslinking of the polymer is performed via metal based ionic crosslinking; and
(G) the at least partially crosslinking of the polymer is performed by exposing the composition to actinic radiation or electron beam radiation.

28. A pressure sensitive adhesive comprising the polymer of claim 1.

29. An article comprising the adhesive of claim 27, the article further comprising a substrate defining a face;
wherein the adhesive is directly coatable on at least a portion of the face of the substrate and does not require a primer disposed in between the adhesive and the substrate.

30. The article of claim 29, wherein the substrate is heat sensitive at temperatures above about 110° C.,
wherein the substrate is selected from the group consisting of polypropylene, polyethylene, and vinyl, and
wherein the polyethylene is selected from the group consisting of linear density polyethylene (LDPE), linear low density polyethylene (LDPE), medium density polyethylene (MDPE), high density polyethylene (HDPE), ultra-high molecular weight polyethylene (UHMWPE), and combinations thereof.

31. An article comprising the adhesive of claim 27, the article further comprising a substrate defining a face;
wherein the adhesive is coatable on a carrier or release liner before transferring it to the substrate; and
wherein the carrier is selected from the group consisting of silicone-coated paper, polyethylene film, polyester film, glassine paper, polycoated Kraft paper, fluoropolymer film, release-coated fabrics, thermoplastic films, polypropylene films, release-coated foils, and polyvinyl chloride (PVC) films.

32. A method of forming a composition comprising a crosslinkable polymer, the method comprising the steps of:
providing the mixture of claim 1;
polymerizing the mixture via a free radical polymerization reaction to form the polymer of claim 1.

33. The method of claim 32 wherein polymerizing comprises heating the mixture.

34. The method of claim 32, wherein polymerizing comprises exposing the mixture to actinic radiation or electron beam radiation.

35. The method of claim 32 further comprising a step of crosslinking the polymer to form an adhesive.

36. The method of claim 35, wherein the adhesive exhibits a plateau shear modulus at 25° C. and 1 radian per second that is between 10⁴ and 10⁷ dynes/cm² as determined by dynamic mechanical analysis (DMA).

37. The method of claim 35, wherein the adhesive is a pressure sensitive adhesive.

38. The method of claim 35, wherein the crosslinking is activatable by at least one of actinic radiation, electron beam radiation, heating, moisture, or metal-based ionic crosslinking.

39. The method of claim 32, wherein the polymerizing of the mixture to form a polymer is performed in one step.

40. The method of claim 32, wherein the polymerizing of the mixture to form a polymer is performed in two or more steps.

41. A polymer blend comprising the first and second polymer of claim 1.

42. A composition comprising a crosslinkable reaction product of a mixture, the mixture comprising:
one or more monomer comprising a single polymerizable ethylenically unsaturated bond, wherein the one or more monomer is selected from the group consisting of (meth)acrylate, (meth)acrylamide, non-(meth)acrylate, and combinations thereof;
one or more initiator; and
a functional agent comprising two or more functional groups,
wherein any one or more of the following statements (A) to (C) applies:
(A) a weight average hydrodynamic radius of a molecule of the crosslinkable reaction product in tetrahydrofuran (THF) solution at 30° C. of less than about 30 nm at a weight average absolute molecular weight (Mw) of about 1,500,000 g/mol or less as determined by Gel Permeation Chromatography-Multi-Angle Light Scattering Detection-Differential Viscometry (GPC-MALS-DV);
(B) an intrinsic viscosity of the crosslinkable reaction product in THE solution at 30° C. of about 1.0 dL/g or less at a weight average absolute molecular weight (Mw) of about 1,500,000 g/mol or less as determined by GPC-MALS-DV; and
(C) the crosslinkable reaction product exhibits a post-polymerization melt viscosity within a range of from 90,000 cps to 7,000,000 cps at a shear rate of about 0.25 s⁻¹ at a temperature of about 110° C. as measured a parallel-plate rheometer.
